(19) United States
(12) Patent Application Publication
(10) Pub. No.: US 2026/0097602 A1
(43) Pub. Date: Apr. 9, 2026

(54) READING DEVICE, READING METHOD, PROGRAM, INSPECTION DEVICE, AND PRINTING SYSTEM

(71) Applicant: FUJIFILM Corporation, Tokyo (JP)

(72) Inventor: Kanji NAGASHIMA, Kanagawa (JP)

(73) Assignee: FUJIFILM Corporation, Tokyo (JP)

(21) Appl. No.: 19/417,286

(22) Filed: Dec. 11, 2025

Related U.S. Application Data
(63) Continuation of application No. PCT/JP2024/016045, filed on Apr. 24, 2024.

(30) Foreign Application Priority Data
Jun. 14, 2023 (JP) 2023-098097

(51) Int. Cl. B41J 29/393; H04N 1/028

(52) U.S. Cl. CPC B41J 29/393; H04N 1/0283; H04N 1/0289; H04N 1/02895; B41J 2203/01

(57) ABSTRACT

Provided are a reading device, a reading method, a program, an inspection device, and a printing system that can acquire preferred read data of a printed image for inspection or the like using the read data of the printed image. A reading device includes an image sensor, an imaging lens, a transmitted illumination device including a transmitted bright-field illumination device and a transmitted dark-field illumination device, and a transmitted illumination condition setting unit that sets transmitted illumination conditions according to a process performed on read data, and controls each of the transmitted bright-field illumination device and the transmitted dark-field illumination device according to transmitted illumination conditions.

### CROSS-REFERENCE TO RELATED APPLICATIONS

The present application is a Continuation of PCT International Application No. PCT/JP2024/016045 filed on Apr. 24, 2024 claiming priority under 35 U.S.C § 119(a) to Japanese Patent Application No. 2023-098097 filed on Jun. 14, 2023. Each of the above applications is hereby expressly incorporated by reference, in its entirety, into the present application.

### BACKGROUND OF THE INVENTION

### 1. Field of the Invention

The present invention relates to a reading device, a reading method, a program, an inspection device, and a printing system.

### 2. Description of the Related Art

In ink jet printing devices, image processing technology is applied to read data of a printed image, for example, to measure the jetting direction accuracy of a nozzle provided in an ink jet head, to correct printing unevenness, and to detect streak-like defects that are likely to occur during printing. A reading device, such as a scanner, is used to read the printed image.

JP2000-266690A discloses a device that switches between dark-field illumination and bright-field illumination to detect scratches and the like on a transmitted document such as a photographic film. The device disclosed in JP2000-266690A comprises a light shielding plate configured to be movable in a sub-scanning direction, and the light shielding plate is moved on a light diffusion plate to block illumination light incident on a lens stop. Therefore, switching to the dark-field illumination in which a transparent document is irradiated only with light obliquely incident from both ends of the light diffusion plate in the sub-scanning direction is implemented.

### SUMMARY OF THE INVENTION

The device disclosed in JP2000-266690A makes fine scratches, foreign substances, and the like on the transparent document less noticeable, thereby suppressing degradation of image quality caused by scratches and the like. On the other hand, in a case where the read data is used to perform the detection of defects in the printed image and the like, the read data in which scratches and the like are not noticeable is not suitable.

The present invention has been made in view of these circumstances, and an object of the present invention is to provide a reading device, a reading method, a program, an inspection device, and a printing system that can acquire preferable read data of a printed image for inspection and the like using the read data of the printed image.

According to a first aspect of the present disclosure, there is provided a reading device comprising: an image sensor that reads a printed image printed on a substrate and generates read data of the printed image; an imaging lens that forms an optical image of the printed image on the image sensor and has a defined visual field representing a range in which an illumination device is disposed such that illumination light is directly incident on the imaging lens; a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens; a transmitted illumination condition setting unit that sets transmitted illumination conditions to be applied to the transmitted illumination device; and one or more first processors, in which the transmitted illumination condition setting unit sets transmitted bright-field illumination conditions to be applied to the transmitted bright-field illumination device and sets transmitted dark-field illumination conditions to be applied to the transmitted dark-field illumination device, according to a process performed on the read data, and the one or more first processors control each of the transmitted bright-field illumination device and the transmitted dark-field illumination device according to the transmitted illumination conditions set by the transmitted illumination condition setting unit.

According to the reading device of the first aspect of the present disclosure, each of the transmitted bright-field illumination device and the transmitted dark-field illumination device is controlled according to the process performed on the read data of the printed image. Therefore, it is possible to acquire the read data of the printed image that is preferable for a process such as inspection using the read data of the printed image.

The printed image may include an inspection image. The inspection image may include a ladder pattern and a gradation pattern.

The transmitted bright-field illumination device is disposed at a position through which the optical axis of the imaging lens passes, and direct light, which is at least a part of the emitted light, can be focused on the image sensor by the imaging lens. In addition, the transmitted dark-field illumination device can be disposed at a position outside a passage range of light incident directly on the imaging lens and can be disposed at a position where not all of direct light of the emitted light is focused on the image sensor by the imaging lens.

The direct light is a light component that travels without being reflected or diffused by the substrate, ink, and the like in the light emitted from the illumination device. The light reflected by the substrate or the like is reflected light and is reflected in various directions. Similarly, the light diffused by the substrate or the like is diffused light and is diffused in various directions. A part of the reflected light and a part of the diffused light can reach the light-receiving surface of the image sensor via the imaging lens.

According to a second aspect, in the reading device according to the first aspect, the transmitted illumination condition setting unit may set an amount of light emitted from the transmitted illumination device, based on a first amount of transmitted light obtained from read data acquired by turning on the transmitted bright-field illumination device to read a non-ink-applied region, which is a region in which no ink is applied, of the substrate or a state in which the substrate is absent or a second amount of transmitted light obtained from read data acquired by turning on the transmitted dark-field illumination device to read the non-ink-applied region of the substrate or the state in which the substrate is absent.

According to this aspect, a reference pixel value of the read data is defined based on the read data of the non-ink-applied region of the substrate or the read data in a state in which the substrate is absent. Therefore, the reading sensitivity of the image sensor can be set based on the defined reference pixel value.

According to a third aspect, in the reading device according to the first aspect or the second aspect, a color sensor or a line sensor may be applied as the image sensor.

According to this aspect, it is possible to read a color image and to generate read data for each color.

According to a fourth aspect, in the reading device according to any one of the first to third aspects, the transmitted dark-field illumination device may include a first transmitted dark-field illumination device that emits illumination light in a first direction and a second transmitted dark-field illumination device that emits illumination light in a second direction different from the first direction.

In this aspect, the first direction and the second direction may be orthogonal to each other.

According to a fifth aspect, in the reading device according to the fourth aspect, the transmitted illumination condition setting unit may set a first transmitted dark-field illumination condition in which either the first transmitted dark-field illumination device or the second transmitted dark-field illumination device is turned on or a second transmitted dark-field illumination condition in which the first transmitted dark-field illumination device and the second transmitted dark-field illumination device are turned on, according to the process performed on the read data.

According to this aspect, the preferable control of the amount of emitted illumination light and the illumination conditions preferable for defect detection are achieved according to the process performed on the read data.

According to a sixth aspect, in the reading device according to any one of the first to fifth aspects, the transmitted illumination device may include a light diffusion member that diffuses emitted light to at least one of the transmitted bright-field illumination device or the transmitted dark-field illumination device.

According to a seventh aspect, the reading device according to any one of the first to sixth aspects may further comprise: a reflected illumination device that is disposed on the same side as the image sensor with respect to a space which is divided into two parts by a plane perpendicular to an optical axis of the imaging lens at a reading position of the image sensor and that irradiates the substrate supported at the reading position with illumination light; a reflected illumination condition setting unit that sets reflected illumination conditions to be applied to the reflected illumination device; and one or more second processors, in which the one or more second processors may control the reflected illumination device according to the reflected illumination conditions.

According to this aspect, the preferable control of the amount of emitted illumination light and the illumination conditions preferable for defect detection are achieved according to the process performed on the read data.

According to an eighth aspect, in the reading device according to the seventh aspect, the reflected illumination device may include a first reflected illumination device that emits illumination light in a third direction, and a second reflected illumination device that emits illumination light in a fourth direction different from the third direction, and the reflected illumination condition setting unit may set a first reflected illumination condition in which either the first reflected illumination device or the second reflected illumination device is turned on or a second reflected illumination condition in which the first reflected illumination device and the second reflected illumination device are turned on, according to the process performed on the read data.

In this aspect, the third direction and the fourth direction may be orthogonal to each other.

According to a ninth aspect, in the reading device according to any one of the first to eighth aspects, in a case where a pixel value of read data is larger in a relatively bright portion than in a relatively dark portion in the printed image, the one or more first processors may set an amount of light emitted from the transmitted dark-field illumination device such that a maximum value of an average value of pixel values of read data of solid images included in a first test image, which is printed on a transparent substrate and includes a plurality of the solid images having different density values for each of one or more ink colors, exceeds an average value of pixel values of read data in a non-ink-applied region of the substrate.

According to this aspect, in the read data, the pixel value of a high-density region of the printed image, which is likely to be affected by noise, is relatively large, and it is possible to obtain the illumination conditions for obtaining the read data preferable for correcting the unevenness of the high-density region.

According to a tenth aspect, in the reading device according to any one of the first to ninth aspects, the one or more first processors may adjust an amount of light emitted from the transmitted dark-field illumination device such that a maximum pixel value in read data of a printed image printed on a transparent substrate is equal to a pixel value of a non-ink-applied region in the substrate.

According to this aspect, the amount of emitted illumination light is controlled such that the read data of the printed image, in which a bright portion having a value larger than the pixel value of the non-ink-applied region in the read data is not lost, is acquired.

According to an eleventh aspect, in the reading device according to any one of the first to tenth aspects, the one or more first processors may adjust an amount of light emitted from the transmitted dark-field illumination device such that a maximum pixel value in read data of a region, in which an amount of ink per unit area is equal to or less than a prescribed amount, among ink-applied regions in a transparent substrate exceeds a pixel value of a non-ink-applied region in the substrate.

According to this aspect, the amount of emitted illumination light is controlled such that the read data of the printed image, in which a dark portion having a value smaller than the pixel value of the ink-applied region in the read data is not lost, is acquired.

According to a twelfth aspect, in the reading device according to any one of the first to eleventh aspects, the one or more first processors may adjust an amount of light emitted from the transmitted illumination device such that a minimum pixel value in read data generated by reading the printed image using the image sensor in a state in which the transmitted illumination device is turned on is larger than a pixel value of the read data corresponding to a dark current of the image sensor.

According to this aspect, it is possible to reduce the influence of noise caused by the dark current of the image sensor in the read data.

According to a thirteenth aspect, in the reading device according to any one of the first to twelfth aspects, the transmitted illumination condition setting unit may define two or more combinations of the illumination conditions of the transmitted bright-field illumination device and the illumination conditions of the transmitted dark-field illumination device and set the combinations of the illumination conditions of the transmitted bright-field illumination device and the illumination conditions of the transmitted dark-field illumination device according to reading conditions of the image sensor.

In this aspect, combinations of the illumination conditions of the transmitted bright-field illumination device and the illumination conditions of the transmitted dark-field illumination device may be stored.

According to a fourteenth aspect, in the reading device according to any one of the first to thirteenth aspects, the transmitted illumination condition setting unit may set a first transmitted illumination condition and a second transmitted illumination condition different from the first transmitted illumination condition for reading of one printed image, the one or more first processors may switch between the first transmitted illumination condition and the second transmitted illumination condition in the reading of the one printed image, and the image sensor may generate first read data to which the first transmitted illumination condition is applied and generate second read data to which the second transmitted illumination condition is applied.

According to this aspect, one printed image can be read once to generate read data for each of a plurality of different illumination conditions.

According to a fifteenth aspect of the present disclosure, there is provided a reading method applied to a reading device including an image sensor that reads a printed image printed on a substrate and generates read data of the printed image, an imaging lens that forms an optical image of the printed image on the image sensor and has a defined visual field representing a range in which an illumination device is disposed such that illumination light is directly incident on the imaging lens, and a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens, the reading method comprising: setting transmitted bright-field illumination conditions to be applied to the transmitted bright-field illumination device and setting transmitted dark-field illumination conditions to be applied to the transmitted dark-field illumination device, according to a process performed on the read data; emitting transmitted bright-field illumination light from the transmitted bright-field illumination device according to the transmitted bright-field illumination conditions; emitting transmitted dark-field illumination light from the transmitted dark-field illumination device according to the transmitted dark-field illumination conditions; and reading the printed image using the image sensor.

According to the reading method of the fifteenth aspect of the present disclosure, it is possible to obtain the same operations and effects as those of the reading device according to the first aspect of the present disclosure. The configuration requirements of the reading device according to the second to fourteenth aspects can be applied to the configuration requirements of the reading method according to other aspects.

According to a sixteenth aspect of the present disclosure, there is provided a program applied to a reading device including an image sensor that reads a printed image printed on a substrate and generates read data of the printed image, an imaging lens that forms an optical image of the printed image on the image sensor and has a defined visual field representing a range in which an illumination device is disposed such that illumination light is directly incident on the imaging lens, and a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens, the program causing a computer to implement: a function of setting transmitted bright-field illumination conditions to be applied to the transmitted bright-field illumination device and setting transmitted dark-field illumination conditions to be applied to the transmitted dark-field illumination device, according to a process performed on the read data; a function of emitting transmitted bright-field illumination light from the transmitted bright-field illumination device according to the transmitted bright-field illumination conditions; a function of emitting transmitted dark-field illumination light from the transmitted dark-field illumination device according to the transmitted dark-field illumination conditions; and a function of reading the printed image using the image sensor.

According to the program of the sixteenth aspect of the present disclosure, it is possible to obtain the same operations and effects as those of the reading device according to the first aspect of the present disclosure. The configuration requirements of the reading device according to the second to fourteenth aspects can be applied to the configuration requirements of the program according to other aspects.

According to a seventeenth aspect of the present disclosure, there is provided an inspection device comprising: a reading device that reads a printed image printed on a substrate and generates read data of the printed image; and an analysis device that analyzes the read data, in which the reading device includes an image sensor, an imaging lens that forms an optical image of the printed image on the image sensor and has a defined visual field representing a range in which an illumination device is disposed such that illumination light is directly incident on the imaging lens, a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens, a transmitted illumination condition setting unit that sets transmitted illumination conditions to be applied to the transmitted illumination device, and one or more first processors, the transmitted illumination condition setting unit sets transmitted bright-field illumination conditions to be applied to the transmitted bright-field illumination device and sets transmitted dark-field illumination conditions to be applied to the transmitted dark-field illumination device, according to a process performed on the read data, and the one or more first processors control each of the transmitted bright-field illumination device and the transmitted dark-field illumination device according to the transmitted illumination conditions set by the transmitted illumination condition setting unit.

According to the inspection device of the seventeenth aspect of the present disclosure, it is possible to obtain the same operations and effects as those of the reading device according to the first aspect of the present disclosure. The configuration requirements of the reading device according to the second to fourteenth aspects can be applied to the configuration requirements of the inspection device according to other aspects.

According to an eighteenth aspect, in the inspection device according to the seventeenth aspect, the transmitted illumination condition setting unit may define two or more combinations of the illumination conditions of the transmitted bright-field illumination device and the illumination conditions of the transmitted dark-field illumination device and set the combinations of the illumination conditions of the transmitted bright-field illumination device and the illumination conditions of the transmitted dark-field illumination device according to reading conditions of the image sensor, and the analysis device may analyze a plurality of read data items generated by applying a plurality of different illumination conditions in a case where one type of analysis process is performed.

According to this aspect, illumination control suitable for the reading conditions of the image sensor is implemented. Therefore, the use of the read data under different illumination conditions makes it possible to perform the analysis process with high accuracy.

According to a nineteenth aspect, in the inspection device according to the seventeenth aspect, the transmitted illumination condition setting unit may set a first transmitted illumination condition and a second transmitted illumination condition different from the first transmitted illumination condition for reading of one printed image, the one or more first processors may switch between the first transmitted illumination condition and the second transmitted illumination condition in the reading of the one printed image, the image sensor may generate first read data to which the first transmitted illumination condition is applied and generate second read data to which the second transmitted illumination condition is applied, and the analysis device may analyze the read data items equal in number to a plurality of illumination conditions in a case where one type of analysis process is performed.

According to this aspect, one printed image can be read only to generate read data items equal in number to the illumination conditions, and analysis operations equal in number to the read data items can be performed on one type of analysis data.

According to a twentieth aspect, in the inspection device according to the nineteenth aspect, the analysis device may perform a magnification process on the read data in a transport direction of the substrate.

According to this aspect, it is possible to match the resolution of a plurality of read data items to the resolution of the image sensor.

According to a twenty-first aspect, in the inspection device according to any one of the seventeenth to twentieth aspects, the transmitted dark-field illumination device may include a first transmitted dark-field illumination device that emits illumination light in a first direction and a second transmitted dark-field illumination device that emits illumination light in a second direction different from the first direction, the transmitted illumination condition setting unit may set a first transmitted dark-field illumination condition in which either the first transmitted dark-field illumination device or the second transmitted dark-field illumination device is turned on or a second transmitted dark-field illumination condition in which the first transmitted dark-field illumination device and the second transmitted dark-field illumination device are turned on, and the analysis device may analyze the read data to detect a defect in the printed image.

According to this aspect, it is possible to perform preferable detection of defects in the printed image.

According to a twenty-second aspect, in the inspection device according to any one of the seventeenth to twenty-first aspects, the inspection device may further comprise a reflected illumination device that is disposed on the same side as the image sensor with respect to a space which is divided into two parts by a plane perpendicular to an optical axis of the imaging lens at a reading position of the image sensor and that irradiates the substrate supported at the reading position with illumination light; a reflected illumination condition setting unit that sets reflected illumination conditions to be applied to the reflected illumination device; and one or more second processors that control the reflected illumination device according to the reflected illumination conditions, in which the reflected illumination device may include a first reflected illumination device that emits illumination light in a third direction and a second reflected illumination device that emits illumination light in a fourth direction different from the third direction, the reflected illumination condition setting unit may set a first reflected illumination condition in which either the first reflected illumination device or the second reflected illumination device is turned on or a second reflected illumination condition in which the first reflected illumination device and the second reflected illumination device are turned on, and the analysis device may analyze the read data to detect a defect in the printed image.

According to this aspect, it is possible to perform preferable detection of defects in the printed image.

According to a twenty-third aspect, in the inspection device according to any one of the seventeenth to twenty-second aspects, the one or more first processors may adjust an amount of light emitted from the transmitted dark-field illumination device such that a maximum pixel value in read data of a region, in which an amount of ink per unit area is equal to or less than a prescribed amount, among ink-applied regions in the transparent substrate exceeds a pixel value of a non-ink-applied region in the substrate, and the analysis device may analyze the read data to detect a defect in the printed image.

According to this aspect, it is possible to perform preferable detection of defects in the printed image.

According to a twenty-fourth aspect of the present disclosure, there is provided a printing system comprising: a printing device; and a reading device that reads a printed image printed on a substrate by the printing device, in which the reading device includes an image sensor that reads the printed image and generates read data of the printed image, an imaging lens that forms an optical image of the printed image on the image sensor and has a defined visual field representing a range in which an illumination device is disposed such that illumination light is directly incident on the imaging lens, a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens, a transmitted illumination condition setting unit that sets transmitted illumination conditions to be applied to the transmitted illumination device, and one or more first processors, the transmitted illumination condition setting unit sets transmitted bright-field illumination conditions to be applied to the transmitted bright-field illumination device and sets transmitted dark-field illumination conditions to be applied to the transmitted dark-field illumination device, according to a process performed on the read data, and the one or more first processors control each of the transmitted bright-field illumination device and the transmitted dark-field illumination device according to the transmitted illumination conditions set by the transmitted illumination condition setting unit.

According to the printing system of the twenty-fourth aspect of the present disclosure, it is possible to obtain the same operations and effects as those of the reading device according to the first aspect of the present disclosure. The configuration requirements of the reading device according to the second to fourteenth aspects can be applied to the configuration requirements of the printing system according to other aspects.

According to a twenty-fifth aspect of the present disclosure, there is provided a reading device comprising: an image sensor that reads a printed image printed on a substrate and generates read data of the printed image; an imaging lens that forms an optical image of the printed image on the image sensor and has a defined visual field representing a range in which an illumination device is disposed such that illumination light is directly incident on the imaging lens; a transmitted illumination device that is disposed at a position facing a light-receiving surface of the image sensor and includes a light diffusion member and a switching member which switches between a proportion of light, which is incident on the light diffusion member and is emitted from within a range of the visual field of the imaging lens, to emitted light and a proportion of light, which is not incident on the light diffusion member and is emitted from outside the range of the visual field of the imaging lens, to the emitted light; a transmitted illumination condition setting unit that sets transmitted illumination conditions to be applied to the transmitted illumination device; and one or more first processors, in which the transmitted illumination condition setting unit sets transmitted bright-field illumination conditions to be applied to transmitted bright-field illumination light which is emitted from within the range of the visual field of the imaging lens and sets transmitted dark-field illumination conditions to be applied to transmitted dark-field illumination light which is emitted from outside the range of the visual field of the imaging lens, according to a process performed on the read data, and the one or more first processors control each of the transmitted bright-field illumination light and the transmitted dark-field illumination light according to the transmitted illumination conditions set by the transmitted illumination condition setting unit.

According to the reading device of the twenty-fifth aspect of the present disclosure, it is possible to obtain the same operations and effects as those of the reading device according to the first aspect. The configuration requirements of the reading device according to the second to fourteenth aspects can be applied to the configuration requirements of the reading device according to other aspects.

According to the present invention, each of the transmitted bright-field illumination device and the transmitted dark-field illumination device is controlled according to the process performed on the read data of the printed image. Therefore, it is possible to acquire the read data of the printed image that is preferable for a process such as inspection using the read data of the printed image.

### BRIEF DESCRIPTION OF THE DRAWINGS

FIG. 1 is a schematic view showing reading as viewed from a direction parallel to a plane of paper of a printed matter to which a non-transparent printing paper is applied.

FIG. 2 is a schematic view showing reading as viewed from a direction parallel to a substrate surface of a printed matter to which a transparent film substrate is applied.

FIG. 3 is a schematic view showing reading of a printed matter in which a white background is used for reading of the printed matter to which the transparent film substrate shown in FIG. 2 is applied.

FIG. 4 is a schematic view showing a printed matter as viewed from a direction parallel to a printing surface PF of the printed matter in which the side of a non-printing surface NPF is an observation side.

FIG. 5 is a schematic view showing a printed matter as viewed from a direction parallel to a printing surface PF of the printed matter in which the side of the printing surface PF is the observation side.

FIG. 6 is a schematic view showing reading using transmitted illumination as viewed from a direction parallel to a printing surface PF of a printed image to which a transparent film substrate is applied.

FIG. 7 is a schematic view showing a transmitted illumination device having relatively high light diffusivity.

FIG. 8 is a schematic view showing a transmitted illumination device having relatively low light diffusivity.

FIG. 9 is a perspective view showing a schematic configuration of a printing system according to an embodiment.

FIG. 10 is a view showing the printing system shown in FIG. 9 as viewed from a substrate width direction.

FIG. 11 is a functional block diagram showing an electric configuration of the printing system shown in FIGS. 9 and 10.

FIG. 12 is a functional block diagram showing an electric configuration of a reading control unit shown in FIG. 11.

FIG. 13 is a block diagram showing an example of a hardware configuration of the electric configuration of the printing system shown in FIG. 9.

FIG. 14 is a flowchart showing a procedure of a reading method according to an embodiment.

FIG. 15 is a table showing an example of use of the illumination device.

FIG. 16 is an explanatory view showing an application example of the embodiment.

FIG. 17 is a schematic view showing an illumination device according to an application example.

### DESCRIPTION OF THE PREFERRED EMBODIMENTS

Hereinafter, preferred embodiments of the present invention will be described in detail with reference to the accompanying drawings. In the specification, the same components are denoted by the same reference numerals, and a redundant description thereof will be omitted as appropriate.

### Description of Problems

In an industrial inkjet printing system that performs printing on a transparent film substrate for flexible packaging used for food packaging and the like, in order to maintain the quality of a printed matter, it is required to measure the jetting direction accuracy of each nozzle, to correct density unevenness, and to inspect defects, such as streaks, in the printed matter. Examples of the film substrate include biaxially oriented polypropylene, unoriented polypropylene, linear low density polyethylene, polyethylene terephthalate, and nylon. The printed matter refers to a substrate on which a product image is printed. In the printed matter that is a product, margins and the like used in a manufacturing stage are removed.

The biaxially oriented polypropylene can be represented by OPP which is an abbreviation for Oriented Polypropylene. The unoriented polypropylene can be represented by CPP which is an abbreviation for Cast Polypropylene. The linear low density polyethylene can be represented by LLDPE which is an abbreviation for Linear Low Density Polyethylene. Polyethylene terephthalate can be represented by PET which is an abbreviation for PolyEthylene Terephthalate. Nylon can be represented by the English notation Nylon.

For the measurement of the jetting direction accuracy of each nozzle and the like described above, in a printing system that performs printing on printing paper, such as non-transparent coated paper that is not transparent, a process of optically reading a printed matter using an in-line scanner, a process of analyzing read data, to which image processing technology is applied, and the like are performed.

On the other hand, in a case where a printed matter, to which a transparent film substrate is applied, is read using a scanner including an imaging element, such as an image sensor, the following problems arise.

### Non-Printed Region is Transparent

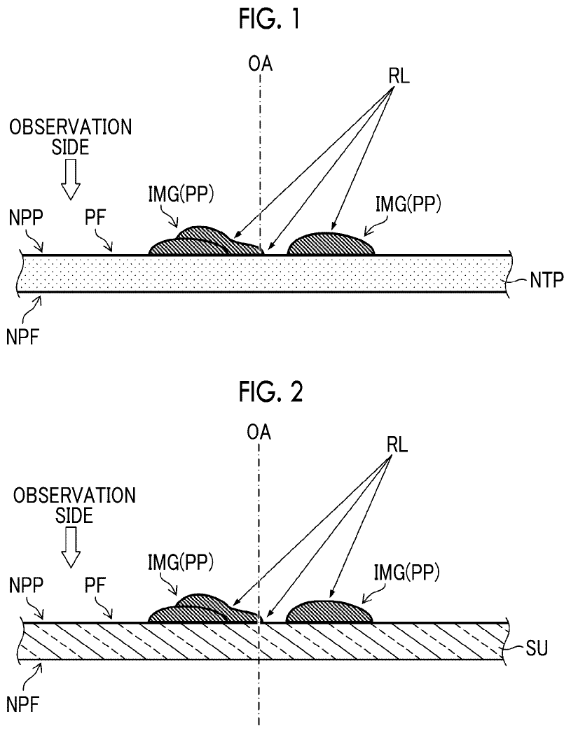

FIG. 1 is a schematic view showing reading as viewed from a direction parallel to a plane of paper of a printed matter to which non-transparent printing paper is applied. In FIG. 1, a state in which a plurality of ink droplets are jetted onto a printed image IMG that is printed on non-transparent printing paper NTP and adhere to the plane of paper in a raised form is shown in an enlarged manner to the extent that the individual ink droplets can be seen, and a state in which a plurality of ink droplets are irradiated with reflected illumination light RL is schematically shown. Letters OA represent an optical axis of an imaging lens provided in a reading device. The same applies to letters OA shown in FIG. 2 and the like. For example, paper having a light transmittance of less than 50% can be applied to the non-transparent printing paper. In addition, letters PF represent a printing surface, and letters NPF represent a non-printing surface.

FIG. 2 is a schematic view showing reading as viewed from a direction parallel to a substrate surface of a printed matter to which a transparent film substrate is applied. In FIG. 2, a state in which a plurality of ink droplets are jetted onto a printed image IMG that is printed on a substrate SU, which is a transparent film, and adhere to the substrate surface in a raised form is shown in an enlarged manner to the extent that the individual ink droplets can be seen, and a state in which a plurality of ink droplets are irradiated with the reflected illumination light RL is schematically shown. For example, a material having a light transmittance of 50% or more can be applied to the substrate SU which is a transparent film.

Here, the printed image IMG represents a region which is defined on the printing paper NTP shown in FIG. 1 and the substrate SU shown in FIG. 2 and in which a product image is printed. The printed image IMG is mainly configured as an ink-applied region PP in which ink is present. The printed image IMG may include a non-ink-applied region NPP in which ink is not present. The non-ink-applied region NPP represents a region in which ink is not present in the substrate SU or the like. The non-ink-applied region NPP may also be present outside the region which is defined on the substrate SU or the like and in which the product image is printed. Hereinafter, the term “substrate SU” represents a medium that is applied to printing and includes the printing paper NTP shown in FIG. 1.

In a case where printing is performed on the printing paper NTP shown in FIG. 1, the printed image IMG can be read using the base color of the printing paper NTP as the background. However, in the non-ink-applied region NPP in which the ink of the printed image IMG printed on the transparent substrate SU shown in FIG. 2 is not present, an object in the background of the substrate SU is visible and read.

That is, in the reading in which the transparent substrate SU is irradiated with the reflected illumination light RL from the observation side, an object located on the non-printing surface NPF of the substrate SU is read as the background. In the reading in which the transparent substrate SU is irradiated with the reflected illumination light RL from the observation side, an object that does not interfere with the analysis of the printed image IMG may be disposed on the non-printing surface NPF of the substrate SU.

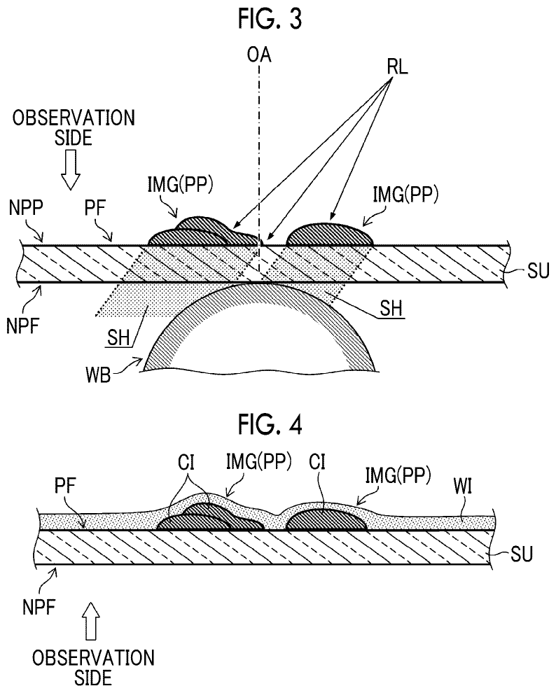

FIG. 3 is a schematic view showing the reading of a printed matter in which a white background is used for reading the printed matter to which the transparent film substrate shown in FIG. 2 is applied. FIG. 3 schematically shows a state in which a white background WB is disposed on the side of the non-printing surface NPF of the transparent substrate SU and the printed image IMG irradiated with the reflected illumination light RL is read. A roller whose outer peripheral surface is painted white is applied as the white background WB shown in FIG. 3. In the reading of the printed image IMG, the white background WB is brought into contact with the non-printing surface NPF of the substrate SU, and the reflected illumination light RL is emitted from the observation side.

The printed image IMG shown in FIG. 3 is separated from the white background WB by a distance corresponding to the thickness of the substrate SU. Therefore, in a case where the reflected illumination light RL is emitted from a direction that is not parallel to the optical axis OA of the imaging lens, there is a problem in that a shadow SH of the printed image IMG printed on the printing surface PF of the substrate SU appears on the white background WB and is reflected in the read data.

### Reading of White Ink

In the printed matter in which the transparent film substrate SU for flexible packaging is used, a background is printed using white ink, depending on the application. In addition, in a case where a white portion is present in an image, such as text, printing is performed using white ink. That is, in printing on the transparent substrate SU, the white ink is used like black ink, cyan ink, magenta ink, yellow ink, and the like.

In printing using the white ink, it is also necessary to perform the above-described measurement of the jetting direction accuracy of each nozzle and the like for the white ink. On the other hand, in a case where the measurement of the jetting direction accuracy of each nozzle and the like are performed, an ink color to be subjected to measurement and the like needs to contrast against the background color for reading.

In a case where printing is performed on white printing paper, the white base of the printing paper serves as the background, color inks, such as black, cyan, magenta, and yellow, can contrast against the white background. However, in a printed matter in which white ink is used in addition to color inks, it is not possible to use white that is the same color as the white ink as the background color.

That is, in a case where the measurement of the jetting direction accuracy of each nozzle and the like are performed, a background of a color that can be distinguished from the color of the ink to be used is required. However, due to the use of the white ink, it is difficult to read a printed matter, in which the white ink and color inks other than the white ink are used, with an appropriate contrast against the background color, using a single background color such as white. The reason is as follows.

First, the colors of cyan ink, magenta ink, and yellow ink used for printing are the three primary colors. In a case where each color is displayed in a color space of an L*a*b* color system, the colors are located at positions separated from each other. In the color space of the L*a*b* color system, the a* and b* values of the black ink and the white ink are approximately 0, the L* value of the black ink is approximately 0, and the L* value of the white ink is approximately 100.

That is, the cyan ink, the magenta ink, the yellow ink, the black ink, and the white ink are located at positions that are separated from each other in the color space of the L*a*b* color system. In a case where a color located at a position separated from any of the above-described colors is selected as the background color, the color is relatively close to a color with the medium density of these inks. Therefore, the contrast against the color with the medium density is small, and it is not possible to read the printed matter with an appropriate contrast against the background color.

### Observation of Non-Printing Surface

In the printed matter in which the printing paper is used, the side of the printing surface PF is an observation side for observing the printed matter. In the printed matter in which the transparent substrate SU shown in FIG. 2 is used, there is a case where the side of the printing surface PF is the observation side, and there is a case where the side of the non-printing surface NPF is the observation side. Which of the side of the printing surface PF and the side of the non-printing surface NPF is the observation side is determined depending on the purpose of the printed matter and the like. In the reading of the printed matter in which both the side of the printing surface PF and the side of the non-printing surface NPF are likely to be the observation side, particularly in a case where the reflected illumination light RL is used, both surfaces may be read using a scanner that is disposed on the side of the printing surface PF of the printed matter and a scanner that is disposed on the side of the non-printing surface NPF. The reason is as follows.

FIG. 4 is a schematic view showing a printed matter as viewed from a direction parallel to the printing surface PF of the printed matter in which the side of the non-printing surface NPF is the observation side. In FIG. 4, a state in which ink droplets of a color ink CI and ink droplets of white ink WI are jetted onto the printing surface PF and adhere to the printing surface PF in a raised form is shown in an enlarged manner to the extent that the individual ink droplets of the color ink CI can be seen. In the printed image IMG shown in FIG. 4, a background of the white ink WI having high covering properties is printed on an uppermost layer of the printing surface PF, and the color inks CI other than the white ink WI are covered with the background of the white ink WI. In this case, even in a case where the printed image IMG is read from the side of the printing surface PF by irradiation with the reflected illumination light RL from the side of the printing surface PF, it is difficult to read the color ink CI covered with the white ink WI from the side of the printing surface PF. Therefore, the printed image needs to be read from the observation side by irradiation with the reflected illumination light RL from the side of the non-printing surface NPF.

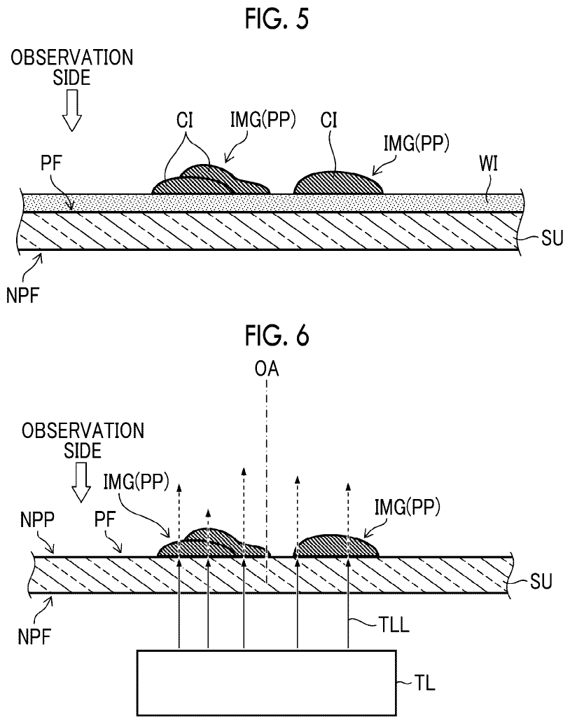

FIG. 5 is a schematic view showing a printed matter as viewed from a direction parallel to the printing surface PF of the printed matter in which the side of the printing surface PF is the observation side. In FIG. 5, a state in which the ink droplets of the color ink CI are jetted onto the printing surface PF and adhere to the printing surface PF in a raised form is shown in an enlarged manner to the extent that the individual ink droplets can be seen. In the printed image IMG shown in FIG. 5, the background of the white ink WI is printed on a lowermost layer, and the color ink CI is printed on the background. In this case, even in a case where the printed image IMG is read from the side of the non-printing surface NPF by irradiation with the reflected illumination light RL from the side of the non-printing surface NPF, it is difficult to read the color ink CI superimposed on the white ink WI from the side of the non-printing surface NPF. Therefore, the printed image needs to be read from the observation side by irradiation with the reflected illumination light RL from the side of the printing surface PF.

Therefore, in a case where the scanners are provided on both the side of the printing surface PF and the side of the non-printing surface NPF of the printed matter, it is possible to perform reading from the printing surface side and reading from the non-printing surface side. However, in this case, the cost of components related to the scanners is doubled as compared to a case where the scanner is provided on either the printing surface side or the non-printing surface side of the printed matter, which is not preferable.

### Method of Solving the Above-Described Problems Arising from Application of Transmitted Illumination

In order to solve the above-described problems, the reading of the printed image using only the transmitted illumination was attempted. FIG. 6 is a schematic view showing reading using transmitted illumination as viewed from a direction parallel to the printing surface PF of the printed image to which a transparent film substrate is applied. In FIG. 6, a state in which ink droplets are jetted onto the printing surface PF and adhere to the printing surface PF in a raised form is shown in an enlarged manner to the extent that the individual ink droplets can be seen. FIG. 6 shows a state in which a transmitted illumination device TL that is disposed on the side of the non-printing surface NPF of the transparent substrate SU used for the printed matter irradiates the non-printing surface NPF of the substrate SU with transmitted illumination light TLL. In FIG. 6, a solid arrow line represents the transmitted illumination light TLL emitted from the transmitted illumination device TL to the substrate SU, and a one-dot chain arrow line represents the transmitted illumination light TLL transmitted through the substrate SU.

A scanner is disposed on the side of the printing surface PF of the substrate SU. The scanner receives the transmitted illumination light TLL transmitted through the substrate SU and generates read data of the printed image IMG. Further, the scanner is not shown in FIG. 6.

In the reading of the printed image IMG shown in FIG. 6, the ink-applied region PP is read more darkly than the non-ink-applied region NPP to the extent that the transmitted illumination light TLL is transmitted according to the transmittance of the substrate SU and the transmittance of the ink and the ink blocks the transmitted illumination light TLL. In the read data, the non-ink-applied region NPP is the brightest. The non-ink-applied region NPP is the background corresponding to the base of the printing paper. In addition, since the transmitted illumination light TLL transmitted through the substrate SU is emitted from the ink-applied region PP of the substrate SU as the background, the shadow of the ink on the printing surface PF does not appear. That is, the problem of the non-ink-applied region NPP being transparent is solved.

The problem of reading the white ink WI will be considered. Since the ink-applied region PP transmits the transmitted illumination light TLL according to the transmittance of the substrate SU and the transmittance of the ink, the ink-applied region PP is read more darkly than the non-ink-applied region NPP. Since the white ink WI also transmits the illumination light according to the transmittance of the ink similarly to the color ink CI, it is possible to read the printed image IMG in which the white ink WI is used.

The problem of observing the non-printing surface NPF will be considered. In a case where the transmitted illumination light TLL is used, the white ink WI and the color ink CI can be read without depending on the order of printing on the transparent substrate SU. In the printed image IMG in which various colors are used, inks of two or three colors are superimposed at the same position in many portions, or ink dots of two or three colors are partially superimposed.

In a case where the scanner is used to emit reflected illumination light RL from the observation side and to read a portion in which the inks are superimposed, the ink dots on the lower side as viewed from the observation side are hidden to some extent due to the covering properties of the ink. On the other hand, in a case where the transmitted illumination light TLL is emitted from the side opposite to the observation side to read the portion in which the inks are superimposed, the ink dots on the lower side as viewed from the observation side are read more clearly than in a case where the reflected illumination light RL is used.

In the reading of the printed image IMG using the transmitted illumination light TLL, the printed image IMG is read as an image in which a plurality of ink dots are superimposed. However, it is possible to detect image defects, such as streaks, in the printed matter because the ink dots of each ink are missing or the positions of the ink dots of each ink deviate.

In the read data of the printed image IMG in a case where the transmitted illumination light TLL is used, the brightness of the ink-applied region PP and the brightness of the non-ink-applied region NPP are considered. In a case where the pixel value of the non-ink-applied region NPP is set to be the same as in a case where the reflected illumination light RL is used, the pixel value of the ink-applied region PP is smaller than in a case where the reflected illumination light RL is used. In this case, a problem occurred in which an SN ratio of the ink-applied region PP in the read data was reduced and the density resolution of a high-density region was reduced.

For example, 8-bit data represented by an integer that is equal to or greater than 0 and equal to or less than 255 is applied as the pixel value of a pixel constituting the printed image IMG, the pixel value of the darkest pixel is 0, and the pixel value of the brightest pixel is 255. In a case where the pixel value of the non-ink-applied region NPP is set to 230, the pixel value of the ink-applied region PP in a case where the transmitted illumination light TLL is used is a value that ranges from one-half to one-third of the pixel value of the ink-applied region PP in a case where the reflected illumination light RL is used. Specifically, in a case where the pixel value of the ink-applied region PP in a case where the reflected illumination light RL is used is 3, the pixel value of the ink-applied region PP in a case where the transmitted illumination light TLL is used is 1.

Hereinafter, an illumination device suitable for reading the printed image IMG printed on the transparent film substrate SU using an ink jet method will be described in detail. According to the illumination device that will be described below, it is possible to adjust the brightness of the ink-applied region PP and the brightness of the non-ink-applied region NPP to an appropriate relationship, suitable brightness is obtained for a process, such as analysis of the read data, a good SN ratio is obtained, and density resolution required in a high-density region on the dark side is obtained.

### Example of Configuration of Transmitted Illumination Device

In order to solve the above-described problems, the light diffusivity of the transmitted illumination device TL was changed, and the printed image IMG on the transparent substrate SU was read using the transmitted illumination light TLL. As a result, it was found that the brightness relationship between the ink-applied region PP and the non-ink-applied region NPP changed due to a difference in the light diffusivity of the transmitted illumination light TLL.

Specifically, in a case where the transmitted illumination light TLL with relatively high light diffusivity, such as illumination light close to complete diffusion, is used, the ink-applied region PP is read more brightly at a relative brightness ratio between the non-ink-applied region NPP and the ink-applied region PP, as compared to a case where the transmitted illumination light TLL with relatively low light diffusivity is used. This makes it possible to relatively increase the SN ratio in the read data and to relatively increase the density resolution in the high-density region. The complete diffusion represents a state in which the brightness of the illumination light appears uniform in all viewing directions. The light diffusivity can be indexed by the ratio between the intensity of light in a normal direction forming an angle of 90° with respect to an emission surface of light and the intensity of light in a direction forming an angle of θ° with respect to a normal line to the emission surface of light. In other words, for the complete diffusion, the intensity of light in the normal direction forming an angle of 90° with respect to the emission surface of light is represented by I₀, and the intensity I(θ) of light in the direction forming an angle of θ° with respect to the normal line to the emission surface of light is represented by I(θ)=I₀×COS(θ).

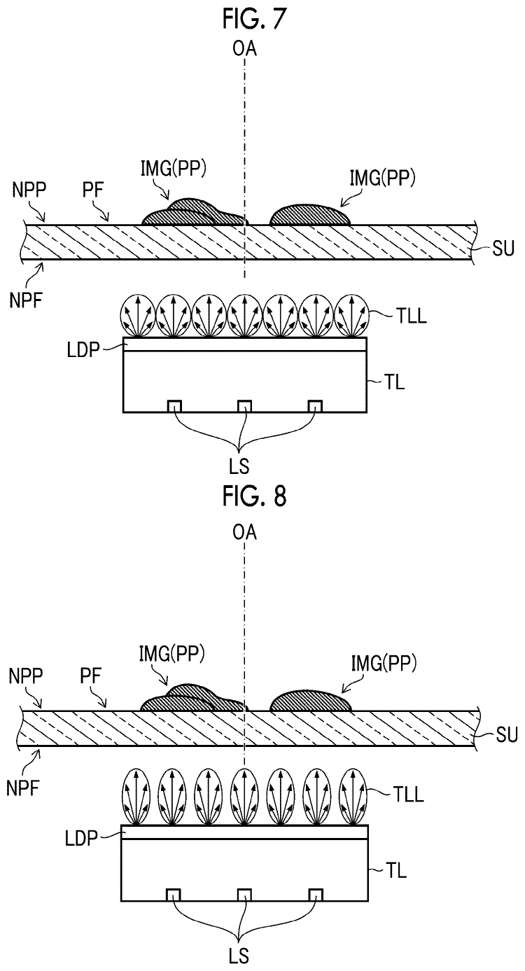

FIG. 7 is a schematic view showing a transmitted illumination device having relatively high light diffusivity. FIG. 8 is a schematic view showing a transmitted illumination device having relatively low light diffusivity. A light diffusion member LDP provided in the transmitted illumination device TL shown in FIG. 7 has a relatively higher light diffusivity than a light diffusion member LDP provided in the transmitted illumination device TL shown in FIG. 8. In FIGS. 7 and 8, the degree of light diffusion is represented by the length of an arrow of the transmitted illumination light TLL and the shape of an ellipse passing through the base and tip of each arrow. An elongated ellipse indicates that the directivity of the transmitted illumination light is high and the light diffusivity is low, while an ellipse closer to a circle indicates that the light diffusion is close to the complete diffusion.

A light source LS provided in the transmitted illumination device TL shown in FIG. 7 is the same as a light source LS provided in the transmitted illumination device TL shown in FIG. 8. That is, the light diffusivity of the transmitted illumination device TL depends on the light diffusivity of the light diffusion member LDP.

However, even in the reading of the printed image IMG using the transmitted illumination light close to the complete diffusion, the light diffusion member LDP needs to be close enough to be in contact with the substrate SU in order to obtain a sufficient effect of the diffused light. In a case where the light diffusion member LDP is not capable of being brought close to the substrate SU, the area of the emission surface of the light diffusion member LDF is relatively increased such that light closer to the horizontal reaches the substrate SU along the optical axis OA.

In the method of bringing the light diffusion member LDP close to the substrate SU, there is a concern that the light diffusion member LDP may come into contact with the substrate SU, causing damage to the substrate SU and malfunction of the transmitted illumination device TL. On the other hand, in the method of relatively increasing the area of the emission surface of the light diffusion member LDF, a modification may occur in which a transport member that supports and transports the substrate SU is disposed not to interfere with the light diffusion member LDF. In addition, in this method, there is a concern that the amount of transmitted illumination light TLL emitted from the light diffusion member LDF may be reduced, and it may be necessary to increase the amount of light emitted from the light source LS. These correspondences can affect the performance and cost of the transmitted illumination device TL.

Further, in the reading of the printed image IMG using the transmitted illumination light close to the complete diffusion, particularly, in a case where a scanner provided with a line sensor is used, there is a problem in which the utilization efficiency of the transmitted illumination light TLL is relatively low. In addition, in the reading of the printed image IMG in which streaks are present, in a case where the transmitted illumination light TLL having low light diffusivity is used, the contrast between the streaks and the printed image IMG is enhanced, and the performance of detecting whether streaks are present or absent can be enhanced, as compared to a case where the transmitted illumination light close to the complete diffusion is used. However, in a case of determining the intensity of streaks rather than the presence or absence of streaks, high density resolution is effective in determining a subtle difference in the density of a streak image, and the use of the transmitted illumination light close to the complete diffusion makes it possible to enhance the performance of determining the intensity of streaks. Overall, in the detection of streaks, it is effective to use the transmitted illumination light close to the complete diffusion.

In summary, it was found that, in the reading of the printed image IMG using the transmitted illumination device TL, there was a light diffusivity suitable for each process in which the read data was used. Specifically, in a case where the ink-applied region PP is read not to be significantly darker than the non-ink-applied region NPP to acquire read data having a relatively high SN ratio and a relatively high density resolution, the light diffusivity may be relatively high. The read data in a case where the light diffusivity is relatively high is suitable for correcting print unevenness and for detecting streak-like defects.

On the other hand, in a case where it is desired to obtain a dark and clear contrast between the ink-applied region PP and the non-ink-applied region NPP, the light diffusivity may be relatively low. The read data in a case where the light diffusivity is relatively low is suitable for measuring the jetting direction accuracy of the nozzle. Hereinafter, a reading device comprising the transmitted illumination devices TL having different light diffusivities and a printing system including the reading device will be described in detail.

### Overall Configuration of Printing System According to Embodiment

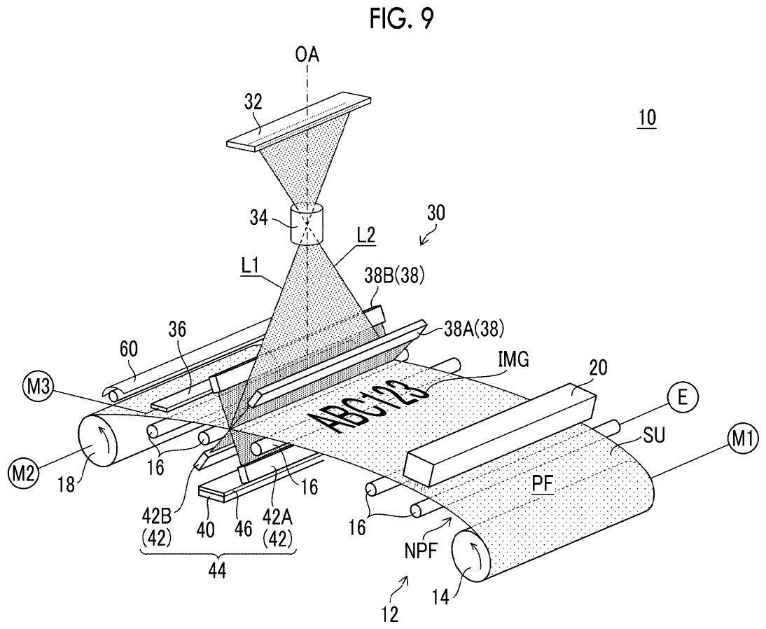

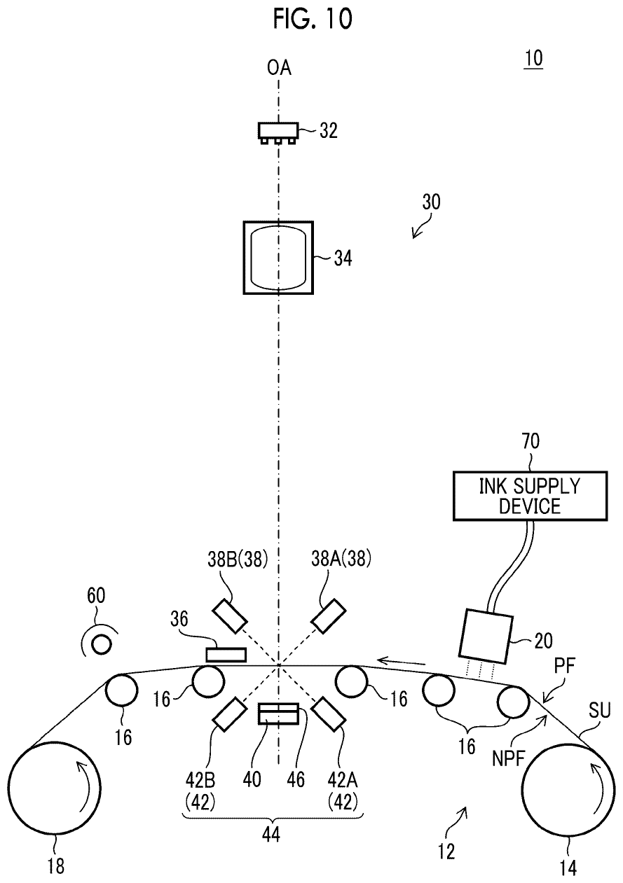

FIG. 9 is a perspective view showing a schematic configuration of a printing system according to an embodiment. FIG. 10 is a view showing the printing system shown in FIG. 9 as viewed from a substrate width direction. Hereinafter, a printing system 10 will be described with reference to FIGS. 9 and 10 as appropriate.

Here, a substrate transport direction is a direction in which the substrate SU travels in the printing system 10. An upstream side in the substrate transport direction represents a supply side of the substrate SU in the substrate transport direction. A downstream side in the substrate transport direction represents a collection side of the substrate SU in the substrate transport direction. In addition, the substrate width direction is a direction orthogonal to the substrate transport direction and is a direction parallel to a transport surface of the substrate SU. Arrow lines shown in FIGS. 9 and 10 represent the substrate transport direction.

The printing system 10 shown in FIG. 9 comprises a transport device 12, a printing device 20, a reading device 30, and a fixing device 60. In addition, as shown in FIG. 10, the printing system 10 comprises an ink supply device 70.

The printing system 10 prints an image on a continuous substrate SU transported by the roll-to-roll transport device 12. The substrate SU shown in FIGS. 9 and 10 is a transparent film. The transport device 12 pulls out the substrate SU from a supply roll 14 around which the substrate SU before printing is wound in a roll shape, supports the non-printing surface NPF of the substrate SU using a plurality of support rollers 16, and transports the substrate SU along the substrate transport direction. The transported substrate SU is wound around a collection roll 18. Further, an arrow line attached to the supply roll 14 indicates a rotation direction of the supply roll 14 in a case where the substrate SU is transported. In addition, an arrow line attached to the collection roll 18 indicates a rotation direction of the collection roll 18 in a case where the substrate SU is transported.

The transport device 12 comprises a tension roller that applies a predetermined tension to the substrate SU, a dancer roller that suppresses a fluctuation in the tension applied to the substrate SU, and a tension pickup that detects the tension applied to the substrate SU. In addition, the tension roller, the dancer roller, and the tension pickup are not shown.

The transport device 12 comprises a motor M1 that functions as a drive source for a winding core constituting the supply roll 14 and a motor M2 that functions as a drive source for a winding core constituting the collection roll 18. The motor M1 and the motor M2 are schematically shown in FIG. 9.

An encoder E is attached to any one of the plurality of support rollers 16. The encoder E may be attached to a rotary shaft of the motor M1 or may be attached to a rotary shaft of the motor M2.

Instead of the roll-to-roll method shown in FIGS. 9 and 10, a method of transporting a sheet-type substrate may be applied to the transport device 12. Any transport method, such as a roller transport method, may be applied to transport the sheet-type substrate.

The printing device 20 performs printing on the substrate SU transported by the transport device 12. That is, the transport device 12 holds a passing position of the substrate SU at a prescribed position with respect to the printing device 20 and maintains a prescribed transport speed.

The printing device 20 comprises a plurality of ink jet heads corresponding to a plurality of ink colors. Examples of the plurality of ink colors include black, cyan, magenta, and yellow. The printing device 20 may be provided with an ink jet head that jets white ink for printing a background on the transparent substrate SU.

The printing device 20 may be provided with ink jet heads corresponding to inks of colors such as green, red, pink, purple, and orange. Therefore, a color image in which various colors are reproduced is printed. In addition, the ink jet head is not shown.

A line head, in which the length of a region in which the nozzles are disposed in the substrate width direction corresponds to the entire width of the substrate SU, can be applied as the ink jet head. An aspect in which a plurality of head modules are arranged along the substrate width direction can be adopted as the line head. A piezo jet method or a thermal method may be applied as a jetting method of the ink jet head.

The printing device 20 jets the inks of the respective colors from the ink jet heads corresponding to the respective colors toward the substrate SU based on print data of a printed image to print a printed image IMG on the printing surface PF of the substrate SU. One or more ink jet heads provided in the printing device 20 are supplied with ink from an ink tank by the ink supply device 70 shown in FIG. 10.

A maintenance device performs maintenance on the ink jet head in order to maintain the jetting performance. Examples of the maintenance of the ink jet head include a dummy jet, purging, and wiping of a nozzle surface.

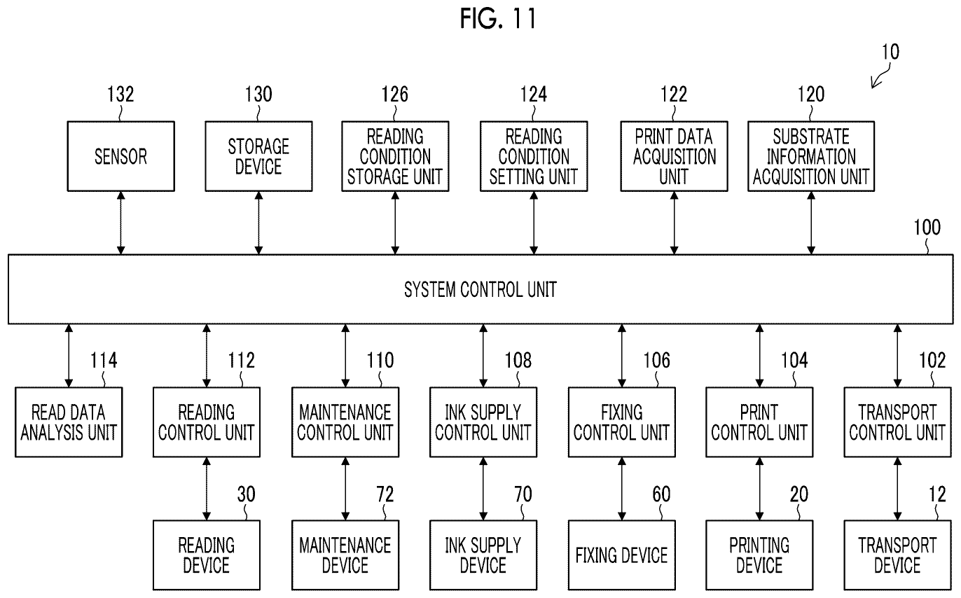

The maintenance device includes a wiping device that wipes the nozzle surface of the ink jet head and a cap that seals the nozzle surface and functions as an ink receiver during a dummy jet and purging. Further, in FIGS. 9 and 10, the maintenance device is not shown. The maintenance device is denoted by reference numeral 72 and is shown in FIG. 11.

The reading device 30 reads the printed image IMG printed on the substrate SU transported by the transport device 12 and generates read data of the printed image IMG. That is, the transport device 12 holds the passing position of the substrate SU at a prescribed position with respect to the reading device 30 and maintains a prescribed transport speed. The read data of the printed image IMG is used for the measurement of the jetting direction accuracy of each nozzle, the correction of density unevenness, the inspection of defects, such as streaks, in the printed matter, and the like.

The reading device 30 comprises an image sensor 32, an imaging lens 34, a reference plate 36, a reflected illumination device 38, a transmitted bright-field illumination device 40, and a transmitted dark-field illumination device 42. A color sensor comprising light-receiving elements corresponding to R, G, and B is applied as the image sensor 32. A line sensor in which a plurality of light-receiving elements are arranged in a row is applied as the image sensor 32. Examples of the image sensor 32 include a CMOS image sensor and a CCD image sensor.

In addition, among R, G, and B, R represents red, G represents green, and B represents blue. CMOS is an abbreviation for Complementary Metal Oxide Semiconductor. CCD is an abbreviation for Charge Coupled Device.

The imaging lens 34 is an optical member that forms an optical image of the printed image IMG printed on the substrate SU supported at a reading position of the image sensor 32 on a light-receiving surface of the image sensor 32. The imaging lens 34 may be configured as an imaging lens group including a plurality of lenses. Letters OA represent an optical axis of the imaging lens 34.

The reference plate 36 is a flat plate whose reading surface read by the image sensor 32 is painted white and is a member that represents reference brightness for white in a case where the image sensor 32 performs reading. The read data of the reference plate 36 is used to calibrate the image sensor 32.

The reference plate 36 is supported to be movable between a reading position and a standby position by a reference plate moving device. A position where the optical axis OA of the imaging lens 34 passes through the reference plate 36 is applied as the reading position. A position outside the visual field of the imaging lens 34 is applied as the standby position. M3 shown in FIG. 9 represents a motor provided in the reference plate moving device that movably supports the reference plate 36.

In a case where the reading device 30 calibrates the brightness of the image sensor 32, the reading device 30 irradiates the reference plate 36 moved to the reading position with the reflected illumination light to read the white color of the reference plate 36 using the image sensor 32 and defines reference brightness based on the read data. The read data of the reference plate 36 may be applied to the shading correction of the image sensor 32.

The reflected illumination device 38 irradiates the printing surface PF of the substrate SU with the reflected illumination light. The reflected illumination device 38 mainly emits the reflected illumination light in a case where the printed matter to which an opaque substrate, such as paper, is applied.

The reflected illumination device 38 shown in FIGS. 9 and 10 includes a first reflected illumination device 38A that is disposed at a position on the upstream side of the reading position of the substrate SU in the substrate transport direction and a second reflected illumination device 38B that is disposed at a position on the downstream side in the same direction. A structure in which a plurality of light source elements are arranged along the substrate width direction can be applied to the first reflected illumination device 38A. A white LED element is given as an example of the light source element. The first reflected illumination device 38A may be provided with an optical member such as a light guide plate. The second reflected illumination device 38B can have the same structure as the first reflected illumination device 38A. In addition, LED is an abbreviation for Light Emitting Diode.

The first reflected illumination device 38A emits illumination light in a third direction. The second reflected illumination device 38B emits illumination light in a fourth direction different from the third direction. FIGS. 9 and 10 show an aspect in which the third direction and the fourth direction intersect each other. The third direction and the fourth direction may be orthogonal to each other.

The transmitted illumination device 44 provided with the transmitted bright-field illumination device 40 and the transmitted dark-field illumination device 42 is disposed at a position that is on the side of the non-printing surface NPF opposite to the printing surface PF of the substrate SU and that faces the light-receiving surface of the image sensor 32. In addition, the printing surface PF of the substrate SU described in the embodiment is an example of a plane perpendicular to the optical axis of the imaging lens. Further, a space in which the reflected illumination device 38 and the transmitted illumination device 44 described in the embodiment are disposed is an example of a space divided into two parts by a plane perpendicular to the optical axis of the imaging lens.

The transmitted illumination device 44 irradiates the substrate SU with the transmitted illumination light in a case where the printed image IMG is read using the image sensor 32. In a case where the printed image IMG of the substrate SU is read using the image sensor 32, the transmitted illumination device 44 and the reflected illumination device 38 may be used in combination.

The transmitted bright-field illumination device 40 is disposed at a position through which the optical axis OA of the imaging lens 34 passes. That is, the transmitted bright-field illumination device 40 is disposed at a position within the range of the visual field of the imaging lens 34. The visual field of the imaging lens 34 represents the position of the transmitted bright-field illumination device 40 where the transmitted illumination light is directly incident on the imaging lens 34.

For example, the visual field of the imaging lens 34 can be understood as a region inside two virtual lines L1 and L2 that start from the ends of the image sensor 32 shown in FIG. 9, pass through the imaging lens 34, and pass through the ends of the substrate SU in the substrate width direction.

The transmitted bright-field illumination device 40 comprises a light diffusion member 46. The light diffusion member 46 is disposed on a transmitted illumination light emission surface. The transmitted bright-field illumination device 40 makes the illumination light emitted from the light source element incident on the light diffusion member 46 such that the non-printing surface NPF of the substrate SU is irradiated with the transmitted illumination light having high brightness uniformity in a plane parallel to the non-printing surface NPF of the substrate SU. The transmitted bright-field illumination device 40 is provided with a plurality of light diffusion members 46 having different light diffusivities, and the light diffusivity can be changed by appropriately changing the light diffusion members 46.

The transmitted dark-field illumination device 42 is provided with a first transmitted dark-field illumination device 42A that is disposed at a position on the upstream side of the reading position of the substrate SU in the substrate transport direction and a second transmitted dark-field illumination device 42B that is disposed at a position on the downstream side in the same direction. The first transmitted dark-field illumination device 42A and the second transmitted dark-field illumination device 42B are disposed at positions outside the visual field of the imaging lens 34. That is, the first transmitted dark-field illumination device 42A and the second transmitted dark-field illumination device 42B are disposed at positions where the transmitted dark-field illumination light emitted from each of the first transmitted dark-field illumination device 42A and the second transmitted dark-field illumination device 42B is not directly incident on the imaging lens 34.

The transmitted dark-field illumination device 42 comprises a light diffusion member, similarly to the transmitted bright-field illumination device 40. The light diffusion member provided in the transmitted dark-field illumination device 42 is not shown. The transmitted dark-field illumination device 42 may comprise a cylindrical lens and focus the illumination light emitted from the light source element on the reading position of the substrate SU using the cylindrical lens. The transmitted dark-field illumination device 42 may comprise a light guide and focus the illumination light emitted from the light source element on the reading position of the substrate SU using the light guide.

The first transmitted dark-field illumination device 42A emits illumination light in a first direction. The second transmitted dark-field illumination device 42B emits illumination light in a second direction different from the first direction. FIGS. 9 and 10 show an aspect in which the first direction and the second direction intersect each other. The first direction and the second direction may be orthogonal to each other.

The fixing device 60 fixes the printed image IMG printed on the substrate SU. That is, the fixing device 60 dries the ink applied to the substrate SU. The fixing device 60 may comprise a heating device, such as a heater, and a blowing device such as a fan.

### Electric Configuration of Printing System

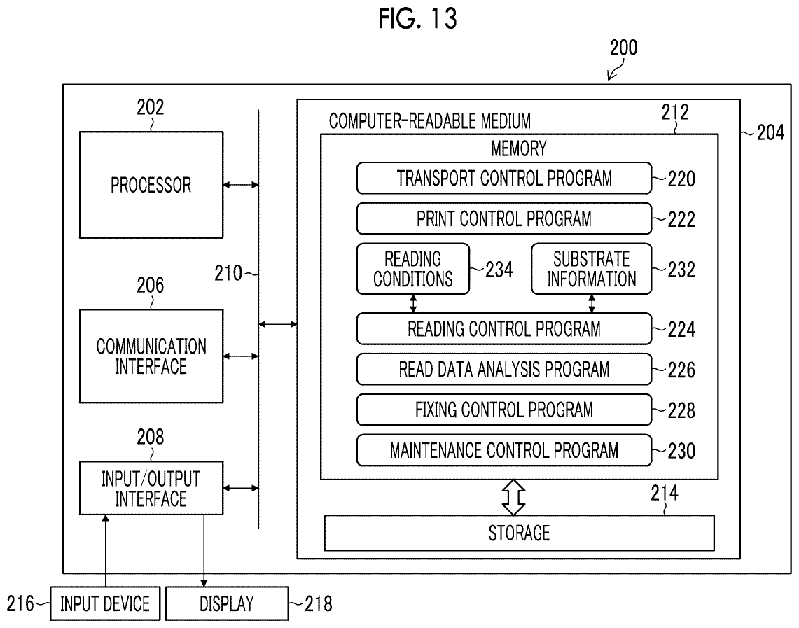

FIG. 11 is a functional block diagram showing an electric configuration of the printing system shown in FIGS. 9 and 10. The printing system 10 comprises a control device to which a computer is applied, and the control device executes various programs corresponding to various functions to implement the various functions. Further, the control device is not shown in FIG. 11. The control device is shown in FIG. 13 using reference numeral 200.

The form of the computer applied to the control device may be a server, a personal computer, a workstation, a tablet terminal, or the like. The form of the computer may be a virtual machine.

The printing system 10 comprises a system control unit 100. The system control unit 100 comprehensively controls the entire printing system 10. That is, the system control unit 100 transmits command signals to various processing units to control each unit of the printing system 10 via the various processing units.

The printing system 10 comprises a substrate information acquisition unit 120. The substrate information acquisition unit 120 acquires information related to the substrate SU used for printing. Examples of the information related to the substrate SU include information indicating whether the substrate SU is transparent or non-transparent, information of a material forming the substrate SU, and information of the size of the substrate SU.

The printing system 10 comprises a print data acquisition unit 122. The print data acquisition unit 122 acquires print data transmitted from an external device such as a server. The print data acquisition unit 122 stores the acquired print data.

The printing system 10 comprises a storage device 130. The storage device 130 stores various types of data, various programs, and various parameters used in the printing system 10. The storage device 130 stores the substrate information acquired by the substrate information acquisition unit 120, the print data acquired by the print data acquisition unit 122, and the like as the various types of data.

The storage device 130 may include a program storage unit that stores various programs, a parameter storage unit that stores various parameters, and a data storage unit that stores various types of data.

The printing system 10 comprises a sensor 132. The sensor 132 includes various sensors provided in the printing system 10. Examples of the sensor 132 include a temperature sensor that measures various temperatures, a position detection sensor that detects the position of the substrate SU, and a tension pickup that measures the tension applied to the substrate SU.

The printing system 10 comprises a transport control unit 102. The transport control unit 102 controls the transport device 12 based on a command signal transmitted from the system control unit 100. The transport control unit 102 sets transport conditions of the transport device 12 according to the substrate information acquired by the substrate information acquisition unit 120. The setting may include the concept of changing preset information.

The transport control unit 102 comprises a motor driver that controls the operations of the motor M1 and the motor M2 shown in FIG. 9. The motor driver performs feedback control on the motor M1 and the motor M2 based on an encoder signal transmitted from the encoder E. In addition, the motor driver is not shown.

The transport control unit 102 controls the tension applied to the substrate SU. The transport control unit 102 performs feedback control on the tension applied to the substrate SU based on a detection signal transmitted from the tension pickup.

The printing system 10 comprises a print control unit 104. The print control unit 104 generates a driving voltage to be supplied to the ink jet head provided in the printing device 20 based on the print data acquired by the print data acquisition unit 122. The ink jet head is subjected to jetting control based on the driving voltage.

That is, the print control unit 104 performs various correction processes, such as a color separation process, a color conversion process, halftone processing, and density correction, on the print data to generate dot data for each color. The print control unit 104 generates the driving voltage to be supplied to the ink jet head based on the dot data for each color. The print control unit 104 supplies the driving voltage to the ink jet head.

In addition, the print control unit 104 sets printing conditions of the printing device 20 according to the substrate information acquired by the substrate information acquisition unit 120. The print control unit 104 may set the printing conditions of the printing device 20 according to the type of ink.

The printing system 10 comprises a fixing control unit 106. The fixing control unit 106 controls the operation of the fixing device 60 according to prescribed fixing conditions, based on a command signal transmitted from the system control unit 100. The fixing control unit 106 sets fixing processing conditions of the fixing device 60 according to the substrate information, the print data, and the like.

The printing system 10 comprises an ink supply control unit 108. The ink supply control unit 108 controls the operation of the ink supply device 70 based on a command signal transmitted from the system control unit 100.

The printing system 10 comprises a maintenance control unit 110. The maintenance control unit 110 controls the operation of the maintenance device 72 based on a command signal transmitted from the system control unit 100.

The printing system 10 comprises a reading control unit 112 and a reading condition setting unit 124. The reading control unit 112 controls the operation of the reading device 30 based on a command signal transmitted from the system control unit 100. The reading condition setting unit 124 sets reading conditions to be applied to the reading device 30.

The reading conditions include image sensor conditions including the reading resolution of the image sensor 32 and illumination conditions including the amount of light emitted from the illumination device. The illumination conditions include reflected illumination conditions applied to the reflected illumination device 38 and transmitted illumination conditions applied to the transmitted illumination device 44. The transmitted illumination conditions include transmitted bright-field illumination conditions applied to the transmitted bright-field illumination device 40 and transmitted dark-field illumination conditions applied to the transmitted dark-field illumination device 42.

The reading condition setting unit 124 can set the reading conditions with reference to the substrate information acquired by the substrate information acquisition unit 120. In addition, the reading condition setting unit 124 can set the reading conditions corresponding to the type of the printed image IMG to be read.

For example, the reading conditions in which the reflected illumination device 38 shown in FIG. 1 is used, the reading conditions in which any one of the first transmitted dark-field illumination device 42A or the second transmitted dark-field illumination device 42B is turned on and the other is turned off, and the like are set for a test image, such as a ladder pattern, used to measure the jetting direction accuracy of each nozzle.

The reading condition setting unit 124 may set the reading conditions to be applied to the reading device 30 with reference to a reading condition storage unit 126 that stores the reading conditions for each of parameters including the type of the substrate SU, the printed image IMG to be read, and the like. In addition, the reading condition setting unit 124 described in the embodiment is an example of a transmitted illumination condition setting unit and is an example of a reflected illumination condition setting unit.

The reading control unit 112 can independently control the operations of the first reflected illumination device 38A, the second reflected illumination device 38B, the transmitted bright-field illumination device 40, the first transmitted dark-field illumination device 42A, and the second transmitted dark-field illumination device 42B. Further, the term “illumination device” represents a generic concept of the first reflected illumination device 38A and the like.

The printing system 10 comprises a read data analysis unit 114. The read data analysis unit 114 analyzes the read data of the printed image IMG acquired via the reading control unit 112 and stores the analysis result. The analysis result of the read data of the printed image IMG is used for the measurement of the jetting direction accuracy of each nozzle and the like.

An analysis process corresponding to the printed image IMG to be read is set in the read data analysis unit 114. For example, a process of measuring the position of each pattern and the width of each pattern is applied to the test image, such as a ladder pattern, used to measure the jetting direction accuracy of each nozzle.

A process of measuring the pixel value of a chart for each density value is applied to a first test image applied to the correction of density unevenness. For a product image in which defects, such as streaks, in a printed matter are inspected, a comparison process with image data of the product image is applied to the product image.

For example, the first test image used to correct density unevenness includes solid images corresponding to each of ten or more types of density values ranging from low density to high density. The solid images for each density value have a rectangular shape that is long in the substrate width direction and are arranged in the order of the density value in the substrate transport direction.

That is, in a case when the read data analysis unit 114 performs one type of analysis process, the read data analysis unit 114 analyzes the same number of read data items as generated for each of a plurality of illumination conditions. In addition, the read data analysis unit 114 described in the embodiment is an example of an analysis device.

### Example of Configuration of Reading Control Unit

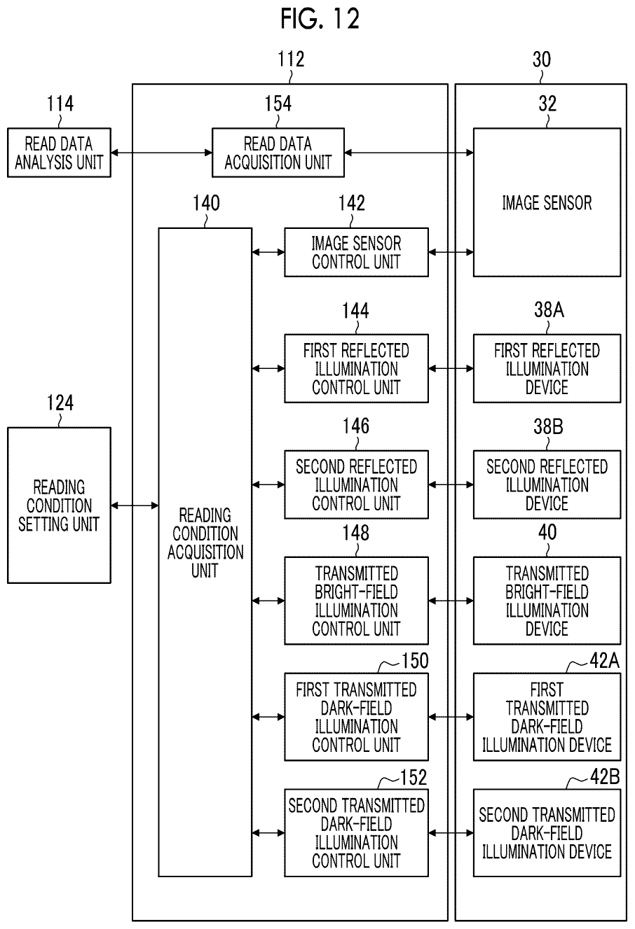

FIG. 12 is a functional block diagram showing an example of a configuration of the reading control unit shown in FIG. 11. The reading control unit 112 comprises a reading condition acquisition unit 140. The reading condition acquisition unit 140 acquires the reading conditions that are set by the reading condition setting unit 124 and are applied to the reading device 30.

The reading control unit 112 comprises an image sensor control unit 142. The image sensor control unit 142 controls the operation of the image sensor 32 based on the image sensor conditions included in the acquired reading conditions. The control content of the image sensor 32 is control of the setting of various parameters generally used to set operating conditions of the image sensor 32, such as adjustment of an amplifier gain for analog output, setting of offset values, setting of a reading cycle, and setting of a shutter speed in the image sensor 32, and control of the reading operation of the image sensor 32.

The reading control unit 112 comprises a first reflected illumination control unit 144. The first reflected illumination control unit 144 controls the amount of light emitted from the first reflected illumination device 38A based on the illumination conditions included in the acquired reading conditions.

The reading control unit 112 comprises a second reflected illumination control unit 146. The second reflected illumination control unit 146 controls the amount of light emitted from the second reflected illumination device 38B based on the illumination conditions included in the acquired reading conditions.

The reading control unit 112 comprises a transmitted bright-field illumination control unit 148. The transmitted bright-field illumination control unit 148 controls the amount of light emitted from the transmitted bright-field illumination device 40 based on the illumination conditions included in the acquired reading conditions.

The reading control unit 112 comprises a first transmitted dark-field illumination control unit 150. The first transmitted dark-field illumination control unit 150 controls the amount of light emitted from the first transmitted dark-field illumination device 42A based on the illumination conditions included in the acquired reading conditions.

The reading control unit 112 comprises a second transmitted dark-field illumination control unit 152. The second transmitted dark-field illumination control unit 152 controls the amount of light emitted from the second transmitted dark-field illumination device 42B based on the illumination conditions included in the acquired reading conditions.

The reading control unit 112 comprises a read data acquisition unit 154. The read data acquisition unit 154 acquires the read data of the printed image IMG transmitted from the image sensor 32, converts the analog read data into digital read data, and transmits the digital read data to the read data analysis unit 114. In the present embodiment, an aspect in which analog-to-digital conversion for generating a 12-bit digital signal from an analog signal is performed, the digital gain is adjusted, and the most significant 10 bits in the 12-bit data are output as the pixel values of the read data of each color is given as an example.

### Hardware Configuration of Control Device Applied to Printing System

FIG. 13 is a block diagram showing an example of a hardware configuration of the electric configuration of the printing device shown in FIG. 11. A control device 200 provided in the printing system 10 comprises a processor 202, a non-transitory tangible computer-readable medium 204, a communication interface 206, and an input/output interface 208.

The processor 202 includes a central processing unit (CPU). The processor 202 may include a graphics processing unit (GPU). The processor 202 is connected to the computer-readable medium 204, the communication interface 206, and the input/output interface 208 via a bus 210. In addition, the processor 202 described in the embodiment is an example of a first processor and is an example of a second processor.

The computer-readable medium 204 includes a memory 212 which is a main storage device and a storage 214 which is an auxiliary storage device. A semiconductor memory, a hard disk device, a solid state drive device, and the like may be applied as the computer-readable medium 204. Any combination of a plurality of devices may be applied as the computer-readable medium 204. The memory 212 corresponds to a part of the storage device 130 shown in FIG. 11.

The hard disk device can be referred to as an HDD which is an abbreviation for Hard Disk Drive. The solid state drive device can be referred to as an SSD which is an abbreviation for Solid State Drive.

The memory 212 of the computer-readable medium 204 stores a transport control program 220, a print control program 222, a reading control program 224, a read data analysis program 226, a fixing control program 228, and a maintenance control program 230. In addition, the memory 212 stores substrate information 232 and reading conditions 234.

The transport control program 220 is applied to the transport control unit 102 shown in FIG. 11 and implements a function of the transport device 12 transporting the substrate SU. The print control program 222 is applied to the print control unit 104 and implements a printing function of the printing device 20.

The reading control program 224 is applied to the reading control unit 112 and implements the function of the reading device 30 reading the printed image IMG with reference to the substrate information 232 and the reading conditions 234. The read data analysis program 226 is applied to the read data analysis unit 114 and implements a read data analysis function.

The fixing control program 228 is applied to the fixing control unit 106 and implements a function of the fixing device 60 fixing the printed image to the substrate SU. The maintenance control program 230 is applied to the maintenance control unit 110 and implements an ink jet head maintenance function.

Various programs stored in the computer-readable medium 204 include one or more instructions. The computer-readable medium 204 stores various types of data, various parameters, and the like.

In the control device 200, the processor 202 executes various programs stored in the computer-readable medium 204 to implement various functions of the printing system 10. The term “program” is synonymous with the term “software”.

The control device 200 executes data communication with an external device via the communication interface 206. Various standards including Universal Serial Bus (USB) may be applied to the communication interface 206. Either wired communication or wireless communication may be applied as a communication form of the communication interface 206. In addition, USB is a registered trademark.

An input device 216 and a display 218 are connected to the control device 200 via the input/output interface 208. An input device, such as a keyboard or a mouse, is applied to the input device 216. Various types of information applied to the control device 200 are displayed on the display 218.

A liquid crystal display, an organic EL display, a projector, or the like may be applied as the display 218. Any combination of a plurality of devices can be applied as the display 218. In addition, EL of the organic EL display is an abbreviation for Electro-Luminescence.

Here, examples of a hardware structure of the processor 202 include a CPU, a GPU, a programmable logic device (PLD), and an application specific integrated circuit (ASIC). The CPU is a general-purpose processor that executes a program and acts as various functional units. The GPU is a processor specialized in image processing.

The PLD is a processor capable of changing a configuration of an electric circuit after manufacturing a device. An example of the PLD is a field programmable gate array (FPGA). The ASIC is a processor comprising a dedicated electric circuit specifically designed to execute a specific process.

One processing unit may be configured by one of these various processors or by a combination of two or more processors of the same type or different types. Examples of a combination of various processors include a combination of one or more FPGAs and one or more CPUs and a combination of one or more FPGAs and one or more GPUs. Another example of the combination of various processors is a combination of one or more CPUs and one or more GPUs.

A plurality of functional units may be configured by using one processor. An example of configuring a plurality of functional units using one processor is an aspect in which one processor is configured by applying a combination of one or more CPUs and software, such as a system on a chip (SoC) represented by a computer, such as a client or a server, and the processor acts as a plurality of functional units.

Another example of configuring a plurality of functional units using one processor is an aspect in which a processor that implements functions of an entire system including a plurality of functional units using one IC chip is used. Further, IC is an abbreviation for Integrated Circuit.

As described above, various types of functional units are configured using one or more of the various types of processors described above as the hardware structure. Furthermore, the hardware structure of the various processors is, more specifically, an electric circuit (circuitry) in which circuit elements, such as semiconductor elements, are combined.

The computer-readable medium 204 may include a semiconductor element such as a read only memory (ROM), a random access memory (RAM), and an SSD. The computer-readable medium 204 may include a magnetic storage medium such as a hard disk. The computer-readable medium 204 may be provided with a plurality of types of storage media.

### Procedure of Reading Method According to Embodiment

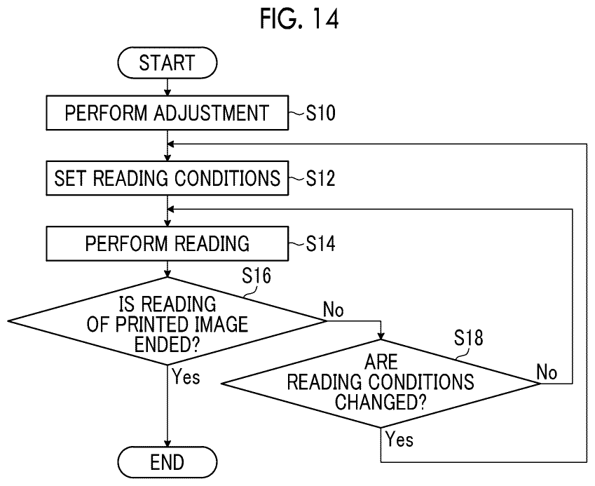

FIG. 14 is a flowchart showing a procedure of a reading method according to the embodiment. In an adjustment step S10, the reading control unit 112 shown in FIG. 11 performs the adjustment of the reading device 30. In the adjustment of the reading device 30, the adjustment of the amount of emitted illumination light, the adjustment of the reading timing, the adjustment of the reading position, and the like are performed according to the type of the substrate SU on which the printed image IMG to be read is printed.

For example, in the adjustment step S10, in a case where the transparent substrate SU is used, the transmitted bright-field illumination device 40 shown in FIG. 9 is turned on, the substrate SU on which printing has not been performed is read using the image sensor 32, the amount of light emitted from the transmitted bright-field illumination device 40 is adjusted based on the read data of the substrate SU, the gain of the amplifier that amplifies the output signal of the image sensor 32 is adjusted, and a bright reference value of the output signal of the image sensor 32 is adjusted. Then, the substrate SU on which printing has not been performed is read using the image sensor 32, without irradiating the substrate SU with illumination light, and a dark reference value of the output signal of the image sensor 32 is adjusted based on the read data. In a case where reading is performed without irradiating the substrate SU with illumination light, the reference plate 36 may be moved to the position, through which the reading optical axis of the image sensor 32 passes, and used as a light shielding plate to block external light. In any of the methods, the brightness of the ambient light at the reading position in a case where the dark reference value is adjusted needs to be sufficiently lower than the brightness of the illumination light at the reading position in a case where the bright reference value is adjusted. The sufficiently dark state is a state in which the brightness is equal to or less than the brightness corresponding to the least significant bit according to the number of bits in a case where the output signal of the image sensor 32 is converted into a digital signal. For example, in a case where the output signal is converted into a 12-bit digital signal, the brightness of the ambient light with respect to the brightness of the illumination light at the reading position in a case where the bright reference value is adjusted is preferably equal to or less than half of 1/2¹²≈0.00024.

In the adjustment step S10, in a case where a paper substrate SU, such as printing paper, is used, the reference plate 36 is moved to the position through which the reading optical axis of the image sensor 32 passes, the first reflected illumination device 38A and the second reflected illumination device 38B are turned on, the amounts of light emitted from the first reflected illumination device 38A and the second reflected illumination device 38B are adjusted, the gain of the amplifier that amplifies the output signal of the image sensor 32 is adjusted, and the bright reference value of the output signal of the image sensor 32 is adjusted based on the read data of the reference plate 36. Then, the reference plate 36 is read using the image sensor 32 without irradiating the reference plate 36 with the illumination light, and the dark reference value of the output signal of the image sensor 32 is adjusted based on the read data of the reference plate 36. In a case where the adjustment of the image sensor 32 and the adjustment of the illumination device, such as the reflected illumination device 38, are ended in the adjustment step S10, the process proceeds to a reading condition setting step S12.

In the reading condition setting step S12, the reading condition setting unit 124 sets the reading conditions corresponding to the type of the substrate and the like. For example, in the reading condition setting step S12, the reading resolution of the image sensor 32 is set according to the transport speed of the substrate SU, the print resolution of the printed image IMG to be read, and the like. In addition, the illumination device is set to be turned on or off depending on the type of the substrate SU, the type of the printed image IMG to be read, and the like. In a case where the reading conditions for the reading device 30 are set in the reading condition setting step S12, the process proceeds to a reading step S14.

In the reading step S14, the reading of the printed image IMG is started at a timing when a head position of the printed image IMG to be read reaches the reading position of the reading device 30. In the reading step S14, a preset reading cycle is applied, and the entire printed image IMG is read. In the reading step S14, the illumination device is operated according to the illumination conditions, and the image sensor 32 is operated according to the image sensor conditions. In a case where the reading step S14 is started, the process proceeds to a reading end determination step S16.

In the reading end determination step S16, the reading control unit 112 determines whether or not the reading of the printed image IMG is ended. In a case where it is determined that the reading of the printed image IMG is continued in the reading end determination step S16, the determination result is No. In a case where the determination result is No, the process proceeds to a reading condition change determination step S18.

In the reading condition change determination step S18, the reading control unit 112 determines whether or not to maintain the reading conditions. In a case where it is determined that the reading conditions are maintained in the reading condition change determination step S18, the determination result is No. In a case where the determination result is No, the process proceeds to the reading step S14, and the reading step S14, the reading end determination step S16, and the reading condition change determination step S18 are repeatedly executed until the determination result is Yes in the reading end determination step S16.

On the other hand, in a case where it is determined that the reading conditions are changed in the reading condition change determination step S18, the determination result is Yes. For example, in a case where the type of the substrate SU is changed and in a case where the type of the printed image IMG is determined to be changed, the determination result is Yes. In a case where the determination result is Yes, the process proceeds to the reading condition setting step S12, and the reading step S14, the reading end determination step S16, and the reading condition change determination step S18 are repeatedly executed until the determination result is Yes in the reading end determination step S16.

On the other hand, in a case where it is determined that the reading of the printed image is ended in the reading end determination step S16, the determination result is Yes. In a case where the determination result is Yes, a prescribed end process is executed, and the procedure of the reading method is ended.

### Specific Example of Control of Illumination Device

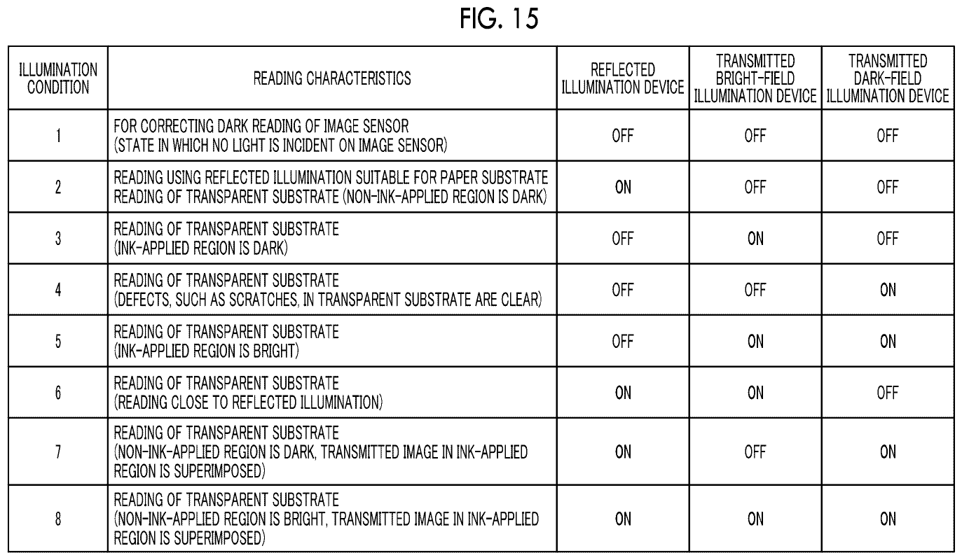

FIG. 15 is a table showing an example of the use of the illumination device. The table shown in FIG. 15 shows a relationship between combinations of the turn-on and turn-off of the reflected illumination device 38, the transmitted bright-field illumination device 40, and the transmitted dark-field illumination device 42 shown in FIG. 9 and reading characteristics.

Illumination condition 1 in which all of the reflected illumination device 38, the transmitted bright-field illumination device 40, and the transmitted dark-field illumination device 42 are turned off is applied to reading in a dark state of the image sensor 32. The dark state of the image sensor 32 is a state in which all of the illumination devices shown in FIG. 9 are turned off, the illumination light used during normal reading is not emitted, and the transmitted illumination light transmitted through the substrate and the reflected illumination light reflected by the substrate do not reach the image sensor 32. In addition, the dark state may be a state in which the substrate is not present and the illumination light used during normal reading is not emitted.

Illumination condition 2 in which the reflected illumination device 38 is turned on and the transmitted bright-field illumination device 40 and the transmitted dark-field illumination device 42 are turned off is applied to the reading of the printed matter in which paper is applied as the substrate SU. The illumination condition 2 is applied to the reading of the printed image IMG in which the transparent substrate SU is applied in a case where the non-ink-applied region NPP is relatively dark.

Illumination condition 3 in which the reflected illumination device 38 and the transmitted dark-field illumination device 42 are turned off and the transmitted bright-field illumination device 40 is turned on is suitable for the reading of the transparent substrate SU and for the reading of the printed image IMG in a case where the ink-applied region PP is relatively dark.

In the illumination condition 3, the transmitted bright-field illumination light whose uniformity has been increased by the light diffusion member 46 is incident on the imaging lens 34. The transmitted bright-field illumination light incident on the imaging lens 34 is incident on all of the light-receiving elements of the image sensor 32. As a result, the reading range of the printed image IMG is read relatively brightly.

The transparent substrate SU supported at the reading position of the image sensor 32 is read such that the non-ink-applied region NPP is read relatively brightly and the ink-applied region PP is read relatively darkly according to the light transmittance of ink and the light diffusivity of ink.

The illumination condition 3 is applied to the reading of the non-ink-applied region NPP of the substrate SU and the acquisition of a first amount of transmitted light represented by the pixel value of the read data. The illumination condition 3 is applied to the acquisition of a second amount of transmitted light represented by the pixel value of the read data in a state in which the substrate SU is absent. The first amount of transmitted light and the second amount of transmitted light are used in a case where the illumination conditions are set.

Illumination condition 4 in which the reflected illumination device 38 and the transmitted bright-field illumination device 40 are turned off and the transmitted dark-field illumination device 42 is turned on is suitable for the reading of the transparent substrate SU in a case where defects, such as scratches on the substrate SU, and image defects, such as scratches on the printed image IMG, are clearly read.

In the illumination condition 4, the transmitted dark-field illumination light emitted from the transmitted dark-field illumination device 42 is not directly incident on the imaging lens 34. However, the ink in the ink-applied region PP diffuses the transmitted dark-field illumination light emitted from the transmitted dark-field illumination device 42. A part of the diffused transmitted dark-field illumination light is incident on the imaging lens 34 and is incident on the light-receiving element of the image sensor 32 such that the ink is read brightly.

That is, since the transmitted dark-field illumination device 42 illuminates the substrate SU from outside the visual field of the imaging lens 34, the transmitted dark-field illumination light does not function as illumination light for the substrate SU having no light diffusivity, but diffused light is generated for the ink having light diffusivity. The diffused light incident on the imaging lens 34 functions as illumination light for the ink, and the ink-applied region PP in which the ink is present is read brightly.

Illumination condition 5 in which the reflected illumination device 38 is turned off and the transmitted bright-field illumination device 40 and the transmitted dark-field illumination device 42 are turned on is applied to the reading of the transparent substrate SU in a case where the ink-applied region PP is relatively bright.

In the illumination condition 5, the amount of light emitted from the transmitted bright-field illumination device 40 and the amount of light emitted from the transmitted dark-field illumination device 42 can be further adjusted to adjust the contrast between the ink-applied region PP and the non-ink-applied region NPP. In addition, in the illumination condition 5, the read data of the printed image IMG including the ink images of all colors is obtained in correspondence with the ink-applied region PP in which the ink images of a plurality of colors are superimposed.

The illumination condition 5 is suitable for the reading of the test image which is the printed image IMG in a case where density unevenness is corrected. In the correction of the density unevenness, the density unevenness is corrected for each color of the printed image IMG from a high-density region to a low-density region.

The test image used for density unevenness correction has solid images having a plurality of different density values for each ink color in the density range applied to printing. It is preferable that the plurality of different density values for each ink color are 10 or more types of density values.

The amount of transmitted illumination light is determined such that, among the solid images having a plurality of different density values for each ink color, the brightest solid image having the minimum amount of ink per unit area and the non-ink-applied region NPP are distinguishable from each other. This makes it possible to distinguish the non-ink-applied region NPP from the low-density ink-applied region PP. In addition, it is obvious that in solid images other than the solid image having the smallest amount of ink per unit area can be distinguished from the non-ink-applied region NPP. Hereinafter, the term “amount of ink” represents the amount of ink per unit area.

In a case where the printed image IMG using cyan ink, magenta ink, yellow ink, and black ink is read by the image sensor 32 of colors corresponding to R, G, and B, the cyan ink is a complementary color of red and absorbs a large amount of red light. Similarly, magenta is a complementary color of green and absorbs a large amount of green light, and yellow is a complementary color of blue and absorbs a large amount of blue light. For the pixel value of the complementary color of each ink color, a larger signal value is obtained as compared to the pixel values of other colors. Therefore, it is easy to distinguish the ink-applied region PP from the non-ink-applied region NPP.

For the black ink and the white ink, the same signal value is obtained for each of R, G, and B. For the black ink and the white ink, the average value of the pixel values of each of R, G, and B may be used. That is, for inks other than the cyan ink, the magenta ink, and the yellow ink, the pixel value of the color with the maximum pixel value among the pixel values of R, G, and B may be used, or the average value of the pixel values of each of R, G, and B may be used. In a case where the maximum pixel value of the color is used, the process is facilitated. On the other hand, in a case where the average value of the pixel values of R, G, and B is used, a random noise component superimposed on the output signal of the image sensor 32 can be reduced by about 40%.

In the actual adjustment, the amount of emitted transmitted illumination light is set such that the non-ink-applied region NPP is dark. However, in a case where the amount of emitted transmitted illumination light is set, the amount of emitted transmitted illumination light is set with a focus on the pixel value of the ink of the color having the smallest difference from the pixel value of the read data of the non-ink-applied region NPP.

Illumination condition 6 in which the reflected illumination device 38 and the transmitted bright-field illumination device 40 are turned on and the transmitted dark-field illumination device 42 is turned off is applied to the reading of the transparent substrate SU in a case where the reading is close to reading using the reflected illumination light RL.

In the illumination condition 6, the ink-applied region PP is irradiated with the illumination light emitted from the reflected illumination device 38, and the surface of the ink-applied region PP is read. In addition, the non-ink-applied region NPP is irradiated with the illumination light emitted from the transmitted bright-field illumination device 40, and the non-ink-applied region NPP is read more brightly than the ink-applied region PP. That is, in the illumination condition 6, it is possible to obtain read data close to the read data of the printed image IMG printed on a white background, such as printing paper. In addition, in the illumination condition 6, the reflection of the shadow SH of the printed image IMG shown in FIG. 3 in the read data is prevented.

Illumination condition 7 in which the reflected illumination device 38 and the transmitted dark-field illumination device 42 are turned on and the transmitted bright-field illumination device 40 is turned off is applied to the reading of the transparent substrate SU in a case where the non-ink-applied region NPP is relatively dark and a transmitted image of the printed image IMG in the ink-applied region PP is read in a state of being superimposed on a reflected image generated in a case where the printed image IMG is irradiated with the illumination light from the reflected illumination device 38. Since the unevenness is emphasized, the illumination condition 7 is suitable in a case where the unevenness is corrected.

Illumination condition 8 in which the reflected illumination device 38, the transmitted bright-field illumination device 40, and the transmitted dark-field illumination device 42 are turned on is applied to the reading of the transparent substrate SU in a case where the non-ink-applied region NPP is relatively bright and the transmitted image of the printed image IMG in the ink-applied region PP is read in a state of being superimposed on the reflected image generated in a case where the printed image IMG is irradiated with the illumination light from the reflected illumination device 38. Since the unevenness is emphasized as in the illumination condition 7, the illumination condition 8 is suitable for a case where the unevenness is corrected. In addition, in the illumination condition 8, in the reading of the test image used for density unevenness correction, the non-ink-applied region NPP is read relatively brightly, and it is easy to separate the solid images that have a plurality of different density values and constitute the test image from the non-ink-applied region NPP.

Here, JP2000-266690A discloses an illumination device that switches between bright-field illumination light and dark-field illumination light in reading of a photographic film in a case where scratches and the like on the photographic film are detected. JP2000-266690A does not disclose the reading of a printed image printed on a transparent substrate SU using a printing device to which an inkjet method or the like is applied.

In contrast, in the method for reading a printed image according to the embodiment, as described above, each of the reflected illumination device 38, the transmitted bright-field illumination device 40, and the transmitted dark-field illumination device 42 is selectively turned on and off, and the amount of light emitted from each illumination device is adjusted to any value. The combinations of turning on and off the reflected illumination device 38, the transmitted bright-field illumination device 40, and the transmitted dark-field illumination device 42 are as shown in the table of FIG. 15.

In addition, the amount of light emitted from each of the reflected illumination device 38, the transmitted bright-field illumination device 40, and the transmitted dark-field illumination device 42 in the on state is adjusted to any value. Therefore, it is possible to select illumination conditions suitable for reading each printed image IMG in each of a case where there is a difference in the amount of ink in the ink-applied region PP, a case where inks of a plurality of colors are superimposed, and a case where the amount of overlap between the inks is relatively small.

In the reading of the printed image IMG, it is necessary that a region having the smallest amount of ink among the ink-applied regions PP can be distinguished from the non-ink-applied region NPP. In this case, in the illumination condition 5, the amount of light emitted from the transmitted bright-field illumination device 40 and the amount of light emitted from the transmitted dark-field illumination device 42 are adjusted such that the brightness of all of the ink-applied regions PP is lower than the brightness of the non-ink-applied region NPP.

In a case where the amounts of light emitted from the transmitted bright-field illumination device 40 and the transmitted dark-field illumination device 42 are adjusted, the illumination condition 5 is suitable for reading the test image applied to measure the jetting direction accuracy of each nozzle, which requires accurate reading of the density of the printed image IMG, and the test image applied to correct density unevenness. In addition, in a case where the test image applied to measure the jetting direction accuracy of each nozzle is an object to be read, the amount of emitted transmitted dark-field illumination light is further reduced with respect to the amount of emitted transmitted bright-field illumination light, and the contrast of line images constituting the test image applied to measure the jetting direction accuracy is relatively increased.

In the illumination condition 5, in a case where the amount of light emitted from the transmitted bright-field illumination device 40 and the amount of light emitted from the transmitted dark-field illumination device 42 are adjusted such that the brightness of a region having low density among the ink-applied regions PP is higher than the brightness of the non-ink-applied region NPP, the brightness of a region having density ranging from medium density to high density among the ink-applied regions PP is lower than the brightness of the non-ink-applied region NPP, and the brightness of the non-ink-applied region NPP is constant, the SN ratio is high from the medium density to the high density where streaks are likely to be noticeable, and the density resolution is enhanced from the medium density to the high density. This illumination condition is applied to the reading of the test image applied to inspect defects, such as streaks, in the printed matter, which makes it possible to read a printed image with improved streak detection accuracy.

In addition, the medium density represents a density range including a density intermediate between a minimum density value on the bright side and a maximum density value on the dark side. In a case where the density value is represented by a value from 0 to 255, for example, a range from 120 to 136 can be used as the medium density. However, the range of the medium density is not limited to the range of 120 to 136 and can be defined as any range including the intermediate value of the density range.

In the reading of the test image applied to inspect defects, such as streaks, in the printed image IMG, instead of the second transmitted dark-field illumination condition in which the first transmitted dark-field illumination device 42A and the second transmitted dark-field illumination device 42B are turned on, the first transmitted dark-field illumination condition in which one of the first transmitted dark-field illumination device 42A and the second transmitted dark-field illumination device 42B among the transmitted dark-field illumination devices 42 is turned on and the other is turned off can be applied.

In addition, in the reading of the test image applied to inspect defects, such as streaks, in the printed matter, in the illumination condition 2, the illumination condition 6, the illumination condition 7, and the illumination condition 8 in which the reflected illumination device 38 is turned on, instead of the second reflected illumination condition in which the first reflected illumination device 38A and the second reflected illumination device 38B are turned on, the first reflected illumination condition in which one of the first reflected illumination device 38A and the second reflected illumination device 38B is turned on and the other is turned off can be applied.

In these illumination conditions, in the inspection of defects, such as streaks, in the printed matter in a case where ink that causes ink dots to rise three-dimensionally is used, reading is performed in a way that emphasizes the shadows of the ink dots in a region in which defects, such as streaks, are present. In addition, in all of the illumination conditions, the brightness of the darkest region in the read data of the ink-applied region PP is greater than a noise value of the image sensor.

The amount of illumination light emitted from each illumination device is adjusted at the startup of the printing system 10 shown in FIG. 9. In addition, the amount of illumination light emitted from each illumination device may be readjusted according to the result of the process in which the read data is used.

Further, the illumination conditions shown in the table of FIG. 15 are an example of two or more predetermined combinations of the illumination conditions of the transmitted bright-field illumination devices and the illumination conditions of the transmitted dark-field illumination device.

### Application Example of Embodiment

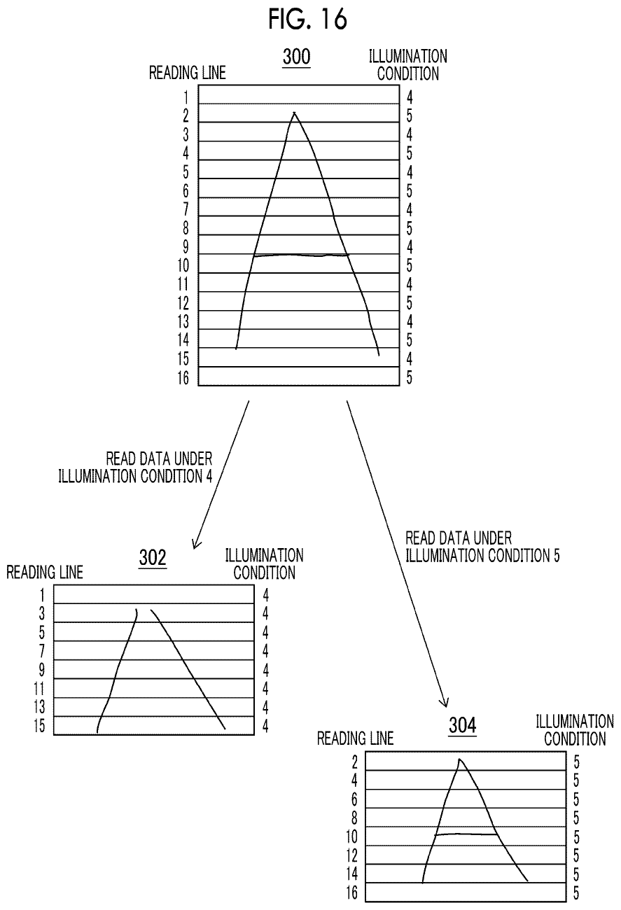

FIG. 16 is an explanatory view showing an application example of the embodiment. FIG. 16 schematically shows the read data of the printed image IMG constituting the printed matter. A line sensor is applied as the image sensor 32 that outputs the read data shown in FIG. 16 and can read the entire width of the substrate SU in the substrate width direction in the reading of one line. Entire read data 300 shown in FIG. 16 represents the entire printed image IMG. In FIGS. 16, 16 reading lines numbered sequentially from 1 to 16 from the top to the bottom are schematically shown on the left side of the entire read data 300. In each reading line shown in FIG. 16, a plurality of pixels are arranged in a row in the left-right direction, and two-dimensional read data is configured as a whole. In the read data read by the image sensor 32 shown in FIG. 9, for example, 7500 pixels are arranged in each reading line. One pixel is composed of data of three colors of red, green, and blue.

In a case where LED light sources or laser light sources are used as the light sources of the reflected illumination device 38, the transmitted bright-field illumination device 40, and the transmitted dark-field illumination device 42, the light sources can be turned on or off at a high speed, or the amount of light can be adjusted. Therefore, in synchronization with the reading of each reading line by the image sensor 32, a predetermined amount of light is applied, and the light source is turned on and off each time each line is read. In the reading of the entire read data 300, any one of the illumination condition 4 or the illumination condition 5 is applied in operative association with the reading of one line by the image sensor 32, one printed image IMG is entirely read, and the entire read data 300 in which lines with different illumination conditions appear alternately is generated.

In the entire read data 300, in the reading of 16 lines, the illumination condition 4 is applied to the reading of the odd-numbered lines, and the illumination condition 5 is applied to the reading of the even-numbered lines. That is, in the entire read data 300, the odd-numbered reading lines to which the illumination condition 4 is applied and the even-numbered reading lines to which the illumination condition 5 is applied are alternately present.

First partial read data 302 to which the illumination condition 4 is applied and second partial read data 304 to which the illumination condition 5 is applied are generated from the entire read data 300. That is, as a result of reading one printed image, a plurality of read data items under different illumination conditions are acquired.

The first partial read data 302 to which the illumination condition 4 is applied is read data suitable for detecting defects, such as streaks, in the printed image in which the transparent substrate SU is used. In addition, the second partial read data 304 to which the illumination condition 5 is applied is read data suitable for density unevenness correction.

In reading using the image sensor 32 having three lines corresponding to R, G, and B colors, respectively, the read data items of each color read at the same timing do not align in position in the printed image and are located at positions that are offset by one line or two lines in the substrate transport direction.

In a case where the image sensor 32 in which the distance between the lines corresponding to each color in the substrate transport direction is one line is used, two types of illumination conditions are alternately switched at each reading timing, and the read data of each color at the same position of the printed image is acquired. In this case, the resolution of the read data in the substrate transport direction for each illumination condition is half of the reading resolution.

In a case where the image sensor 32 in which the distance between the lines corresponding to each color in the substrate transport direction is two lines is used and the reading of three lines is performed, the read data of each color at the same position of the printed image IMG is acquired. In this case, three types of illumination conditions are switched in order at each reading timing.

In a case where two types of illumination conditions are applied, one of the illumination conditions is applied to read two lines, and the other illumination condition is applied to read one line. In addition, in a case where two types of illumination conditions are applied, the reading cycle of the image sensor 32 is set to ⅔ of the reading cycle in a case where the illumination conditions are not switched, and the two types of illumination conditions are alternately switched at each reading timing.

In the read data in a case where the illumination conditions are switched, the number of reading lines in the same illumination condition is reduced and the resolution is lowered as compared to the read data in a case where the illumination conditions are not switched. Therefore, as necessary, a magnification process is performed in the substrate transport direction to generate read data having a predetermined resolution. In the present embodiment, the line sensor is given as an example of the image sensor 32. However, an area sensor may be applied as the image sensor 32.

Further, the illumination condition 4 applied to the reading of the odd-numbered lines described in the embodiment is an example of the first transmitted illumination condition, and the illumination condition 5 applied to the reading of the even-numbered lines is an example of the second transmitted illumination condition. In addition, the first partial read data 302 described in the embodiment is an example of first read data, and the second partial read data 304 is an example of second read data.

### Application Example of Illumination Device

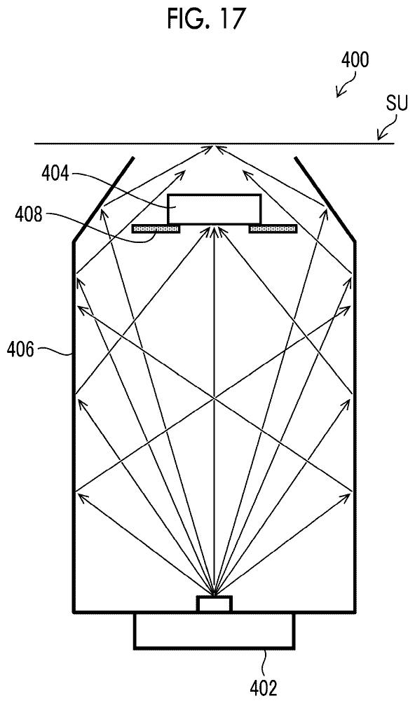

FIG. 17 is a schematic view showing an illumination device according to an application example. FIG. 17 schematically shows a structure of an illumination device 400 having a length corresponding to the entire width of the substrate SU in the substrate width direction. The illumination device 400 shown in FIG. 17 has the functions of the transmitted bright-field illumination device 40 shown in FIG. 1 and has the functions of the transmitted dark-field illumination device 42. In addition, the substrate width direction is a direction penetrating the plane of paper shown in FIG. 17.

The illumination device 400 comprises an LED light source 402, a diffusion plate 404, a mirror box 406, and a pair of movable reflective plates 408. The pair of movable reflective plates 408 are configured to be movable in a direction in which the distance between the pair of movable reflective plates 408 is increased or decreased in the left-right direction in FIG. 17 by the driving of a motor (not shown). An inner surface of the mirror box 406, a front surface of the movable reflective plate 408, and a back surface of the movable reflective plate 408 are mirror surfaces having a light reflectance of approximately 90% or more. An arrow line shown inside the mirror box 406 represents illumination light emitted from the LED light source 402.

The illumination light emitted from the LED light source 402 is divided into light that directly reaches the diffusion plate 404, light that is reflected by the inner surface of the mirror box 406 and reaches the diffusion plate 404, light that reaches the movable reflective plate 408, and light that passes through left and right gaps of the pair of movable reflective plates 408.

In addition, the light that reaches the movable reflective plate 408 is reflected by the front surface of the movable reflective plate 408, is repeatedly reflected by the inner surface of the mirror box 406, and is divided into light that reaches the diffusion plate 404, light that reaches the movable reflective plate 408, and light that passes through the left and right gaps of the pair of movable reflective plates 408. The light that reaches the diffusion plate 404 is bright-field illumination light, and the light that passes through the left and right gaps of the pair of movable reflective plates 408 is dark-field illumination light.

The movable reflective plate 408 has a function of branching the reached illumination light into bright-field illumination light and dark-field illumination light. The ratio of the light that reaches the diffusion plate 404 to the light that passes through the left and right gaps of the pair of movable reflective plates 408 is determined according to the position of the movable reflective plates 408. Therefore, the movable reflective plates 408 adjust the ratio of the bright-field illumination light to the dark-field illumination light according to the position. The movable reflective plates 408 and the mirror box 406 do not need to be flat reflective members and may be curved reflective members with an arcuate cross section or the like. Further, the movable reflective plates 408 described in the embodiment are an example of a light diffusion member.

That is, a part of the branched illumination light reaches the diffusion plate 404 and is emitted as the transmitted bright-field illumination light to the reading position of the image sensor 32. The Illumination light that does not reach the diffusion plate 404 is emitted as the transmitted dark-field illumination light to the reading position of the image sensor 32 from outside the visual field of the imaging lens 34.

The ratio of the transmitted bright-field illumination light to the transmitted dark-field illumination light is determined according to the position of the pair of movable reflective plates 408. In other words, the illumination device 400 can adjust the ratio of the transmitted bright-field illumination light to the transmitted dark-field illumination light according to the position of the pair of movable reflective plates 408. The adjustment of the amount of emitted transmitted bright-field illumination light and the adjustment of the amount of emitted transmitted dark-field illumination light can be implemented by adjusting the amount of light emitted from the LED light source 402.

In addition, the pair of movable reflective plates 408 described in the embodiment are an example of a switching member that switches between the proportion of light, which is incident on the light diffusion member and is emitted from within the range of the visual field of the imaging lens, to the emitted light and the proportion of light, which is not incident on the light diffusion member and is emitted from outside the range of the visual field of the imaging lens, to the emitted light.

In the illumination device 400, the amount of light emitted from the LED light source 402 is adjusted and the position of the movable reflective plates 408 is adjusted according to the illumination conditions shown in FIG. 15. The illumination device 400 has the disadvantage that the amount of light emitted from the LED light source 402 is increased as compared to a case where the transmitted bright-field illumination device 40 and the transmitted dark-field illumination device 42 are separately provided. However, the transmitted bright-field illumination device 40 and the transmitted dark-field illumination device 42 are integrated, and the number of light sources and the number of driving power supplies for the light sources are reduced.

In addition, the illumination device 400 requires members, such as the diffusion plate 404 and the movable reflective plates 408. However, these members can be manufactured using a sheet metal component and a drawn metal component and are less expensive than light sources. Therefore, the desired effects can be achieved with a cost-reduced configuration. Further, in a case of a reading device that is mounted on a printing system having a relatively low printing speed, the reading speed is also slow, and the absolute amount of light required can be reduced. In a configuration in which one light source is used, illumination light whose amount is suitable for reading can be obtained.

### Specific Example of Read Data

The read data generated by reading the printed image using the image sensor 32 is digital data and can be understood as having the same structure as an image in which a plurality of pixels are arranged two-dimensionally. In a case where the read data is regarded as image data, each pixel has a pixel value corresponding to the brightness at each position of the printed image IMG.

The pixel value is the output signal value of the image sensor 32 and is represented in a digital format. In a case where the pixel value is represented as 8-bit digital data, each pixel has a pixel value represented by an integer in a range of 0 to 255. In a case where the pixel value is represented as 10-bit digital data, each pixel has a pixel value represented by an integer in a range of 0 to 1023.

In a case where an RGB color sensor is applied as the image sensor 32, each pixel has a pixel value of each of R, G, and B. In addition, some color sensors have L*a*b* outputs. The form of the output signal of the image sensor 32 is caused by the characteristics of the color filter provided in the image sensor 32.

In the present embodiment, pixel values, which are represented as 8-bit digital data and in which a pixel value on the darkest side is 0 and a pixel value on the brightest side is 255, are given as an example. However, in some cases, the brightness of an image on the brightest side exceeds 255, which is the maximum value of the pixel value, due to a variation in the substrate SU, a variation in the distribution of the amount of emitted illumination light, a change in the amount of emitted illumination light over time, a fluctuation in the sensitivity of the image sensor 32, and the like. In a case where the brightness of the image exceeds 255, which is the maximum value of the pixel value, it is generally referred to as an overflow, and the pixel value of the pixel whose brightness has overflowed is 255. In this case, it is difficult to normally read the printed image IMG. Therefore, the reading conditions of the image sensor 32 are defined such that a margin is provided for the pixel values of the read data and the pixel values of the read data of the non-ink-applied region NPP are around 230. The value of the margin is mainly determined according to an illuminance distribution in the illumination device used, the magnitude of a fluctuation in the brightness of the illumination device used, a variation in the sensitivity of the image sensor used for each pixel, and the magnitude of a fluctuation in the sensitivity of the image sensor used.

A reading condition in which an upper limit value of the pixel value on the brightest side is defined is applied, and the pixel value of the read data of the printed image IMG printed on the transparent substrate SU can be defined as the amount of light transmission of the ink at each position in the printed image IMG.

In a case where the amount of emitted illumination light is determined, the pixel value of each pixel in the read data of a prescribed pattern is acquired. In a case where the prescribed pattern is a solid image that has a uniform density and includes a plurality of pixels, the average value of the pixel values of the plurality of pixels can be defined as the amount of light transmission of the prescribed pattern.

In a case where the average value of the pixel values of a plurality of pixels constituting a pattern is calculated, a random error component is reduced to 1/the square root of the number of pixels used to calculate the average value. For example, in a case where the number of pixels used to calculate the average value is 100, the random error component is reduced to 1/10.

### Specific Example of Adjustment of Amount of Emitted Illumination Light

In the control of the brightness represented by the pixel value of the read data of the printed image IMG, the amount of light emitted from the transmitted bright-field illumination device 40 and the amount of light emitted from the transmitted dark-field illumination device 42 are determined such that the non-ink-applied region NPP of the substrate SU has a prescribed brightness and the maximum pixel value of the read data of the ink-applied region PP is equal to the pixel value of the read data of the non-ink-applied region NPP.

The term “being equal” may include “being the same” and a case where a difference is less than the reading resolution of the image sensor. An example of the prescribed brightness of the non-ink-applied region NPP is a pixel value of 230 in a case where the pixel value of the read data is represented as an integer from 0 to 255.

In the adjustment of the amount of emitted illumination light, the amount of emitted illumination light is set such that the ink-applied region PP is darker than the non-ink-applied region NPP. The degree to which the ink-applied region PP is dark is defined such that, in a case where the pixel value of the read data of the non-ink-applied region NPP is 230, in an ink color in which a difference between the maximum value of the pixel value of the read data and the pixel value of 230 is the smallest, the pixel value in the read data of a solid image with a print density of 0.25 or more and 0.35 or less is 103 or more and 129 or less. In addition, in a case where the intensity of light incident on the surface of the printed matter is Iᵢₙ and the intensity of light reflected from the surface of the printed matter is Iₒᵤₜ, print density D is a relative value represented by D=Log₁₀(Iᵢₙ/Iₒᵤₜ). Further, Log₁₀ is a logarithm with 10 as the base. For example, in a case where the intensity of light reflected from the surface of the printed matter is half of the intensity of light incident on the surface of the printed matter, D is approximately 0.3.

In the illumination state in which the amount of emitted light is adjusted in this way, the maximum pixel value of the read data of the ink-applied region PP is equal to the pixel value of the read data of the non-ink-applied region NPP.

For example, in a case where the print density of the solid image is in a print density range of 0.25 or more and 0.35 or less and the pixel value in the read data of the solid image is 103 or more and 129 or less, appropriate accuracy is obtained in image processing on the test image for density unevenness correction in a range in which the print density is relatively low. In a case where the print density of the solid image is in a print density range of less than 0.25 and the pixel value in the read data of the solid image is less than 103, the pixel value in the read data is relatively small, and calculation errors are relatively large due to a reduction in density resolution. As a result, there is a concern that correction accuracy may be reduced.

In addition, in a case where the print density of the solid image is in a print density range exceeding 0.35 and the pixel value in the read data of the solid image exceeds 129, in the test image that is used for density unevenness correction and that is composed of a plurality of solid images having different densities, the pixel value in the read data of the solid image having the lowest density may exceed 255, and the overflow of the pixel value may occur. In a case where the overflow of the pixel value occurs, there is a concern that appropriate unevenness correction may not be performed in a range in which the density is low.

### Improvement of Quality in Analysis of Read Data

In the control of the brightness represented by the pixel value of the read data of the printed image IMG, the amounts of light emitted from the transmitted bright-field illumination device 40 and the transmitted dark-field illumination device 42 are determined such that the non-ink-applied region NPP of the substrate SU has a prescribed brightness and the maximum pixel value in the read data of a region, in which the amount of ink is equal to or less than a prescribed amount, in the ink-applied region PP exceeds the pixel value of the non-ink-applied region NPP.

The above-described adjustment of the amount of emitted illumination light is intended to improve the quality of processing on the read data of a region, in which the amount of ink is relatively large, in the ink-applied region PP. In the ink-applied region PP, a bright region in which the amount of ink is relatively small has a relatively large pixel value in the read data, is less likely to be affected by noise, and has high pixel value resolution.

On the other hand, in the ink-applied region PP, a dark region in which the amount of ink is relatively large has a relatively small pixel value in the read data, is more likely to be affected by noise, and has low pixel value resolution. In particular, in a region in which the amount of black ink is maximized, the pixel value is around 3, and for example, the accuracy of density unevenness correction is not sufficient.

Therefore, the region, in which the amount of ink is equal to or less than a prescribed amount, in the ink-applied region PP is optionally determined, and the amounts of light emitted from the transmitted bright-field illumination device 40 and the transmitted dark-field illumination device 42 are determined such that the pixel value of the read data of the region, in which the amount of ink is equal to or less than the prescribed amount, is larger than the pixel value of the read data of the non-ink-applied region NPP. In a case where the pixel value is represented by an integer from 0 to 255, a pixel value of 230 can be applied as the pixel value of the read data of the non-ink-applied region NPP.

As a result, the dark region, in which the amount of ink is relatively large, in the ink-applied region PP is relatively bright, is relatively less affected by the noise of the image sensor 32, and has relatively high pixel value resolution. Therefore, the density unevenness of the high-density region can be appropriately corrected.

On the other hand, in the ink-applied region PP, in the region in which the amount of ink is equal to or less than the prescribed amount, particularly, in the region in which the amount of ink is relatively small, the pixel value may exceed the maximum value of 255, and accurate read data may not be obtained. Hereinafter, measures for the case where the pixel value exceeds the maximum value and accurate read data is not capable of being obtained will be described.

In a case where the test image is read by the image sensor 32, the amount of light emitted from the transmitted illumination device 44 is adjusted such that the pixel value of the read data of the non-ink-applied region NPP is around 230, and the adjustment of the amount of emitted illumination light applied to the reading of the solid image having a density value equal to or less than a prescribed density value and the adjustment of the amount of emitted illumination light applied to the reading of the solid image having a density value exceeding the prescribed density value are selectively switched.

In the reading of the solid image having a density value equal to or less than the prescribed density value, the amount of emitted illumination light is adjusted such that the maximum pixel value of the read data of the ink-applied region PP is equal to the pixel value in the read data of the non-ink-applied region NPP.

In addition, in the reading of the solid image having a density value exceeding the prescribed density value, the amount of emitted illumination light is adjusted such that the maximum pixel value of the read data of the region, in which the amount of ink is equal to or less than the prescribed amount, among the ink-applied regions PP exceeds the pixel value of the read data of the non-ink-applied region NPP.

In a case where the amount of emitted illumination light is adjusted in this way, a state in which the pixel value of the read data exceeds 255 and the read data is not read as an image is avoided. In addition, the dark region, in which the amount of ink is relatively large, in the ink-applied region PP is read relatively brightly.

In a case where the amount of emitted illumination light is adjusted in this way, the amount of emitted illumination light is different between the region in which the amount of ink is equal to or less than the prescribed amount and the region in which the amount of ink exceeds the prescribed amount. Therefore, relative correction of the read data in each region is required.

The amount of emitted illumination light applied to the region in which the amount of ink is equal to or less than the prescribed amount is denoted by A, and the amount of emitted illumination light applied to the region in which the amount of ink exceeds the prescribed amount is denoted by B. The amount of emitted illumination light A exceeds the amount of emitted illumination light B.

The read data of the region in which the amount of ink exceeds the prescribed amount is multiplied by A/B to correct the read data of the region in which the amount of ink exceeds the prescribed amount. In a case where the pixel value of each of the above-described read data items is represented by an 8-bit integer, an integer having a number of bits exceeding 8 bits, such as 16 bits, may be applied to the pixel value during multiplication. As a result, the occurrence of overflow during multiplication is suppressed.

The following measures are employed for the reading of the image used to inspect image defects such as streaks. First, the amount of light emitted from the transmitted illumination device 44 is adjusted such that the pixel value of the read data of the non-ink-applied region NPP is 255.

In the inspection of the image defects, the pixel value of the read data is not important, and it is sufficient that the effective read data of the ink-applied region PP is obtained and the pixel value of the read data is relatively large. As a result, the influence of noise superimposed on the read data is reduced, and the resolution of the read data is relatively high.

In a region with a relatively small density value in the ink-applied region PP, image defects, such as streaks, are less likely to be visually recognized. Therefore, in a region with a relatively high density value in which the image defects are more likely to be visually recognized, the amount of emitted illumination light is adjusted such that the pixel value of the read data of the region having the minimum density value is 255.

As a result, a pixel value within the widest possible range obtainable in the read data is obtained from the region with a relatively small print density value to the region with a relatively large print density value in the range of the print density values in which streaks and the like are more likely to be visually recognized, and a certain level of accuracy is ensured in the inspection of the image defects.

In addition, the print density value at which the image defects are less likely to be visually recognized is approximately 0.1 or less in the black ink in which the image defects are most noticeable. However, the print density value at which the image defects are less likely to be visually recognized varies depending on the type of ink.

### Countermeasures Against Noise Caused by Dark Current of Image Sensor

Countermeasures against noise occurring in the image sensor 32 will be described. In a case where the printed image IMG is irradiated with the illumination light and subsequently read, the amount of emitted illumination light is adjusted such that the pixel value of the read data of the darkest region among the ink-applied regions PP exceeds a pixel value corresponding to the dark current of the image sensor 32.

The noise caused by the dark current of the image sensor 32 is ascertained based on the read data in a dark state. The pixel value of the read data generated by reading the printed image IMG in the dark state represents noise corresponding to the dark current. The average value of the pixel values of the respective pixels in the read data is applied as the pixel value representing the noise corresponding to the dark current.

As the countermeasures against noise in the read data, the amount of emitted illumination light is adjusted such that the minimum pixel value in the read data of the printed image IMG is larger than the pixel value of the read data corresponding to the dark current generated in the image sensor 32.

Being larger than the pixel value corresponding to the dark current means that, in a case where the pixel value of the read data is used as it is in analysis of the read data, the minimum pixel value in the read data in a case where the illumination device is turned on is larger than a value obtained by adding a standard deviation of the pixel values of the respective pixels of the read data in the dark state to the average value of the pixel values of the respective pixels of the read data in the dark state.

Being larger than the pixel value corresponding to the dark current means that, in a case where n is set to an integer equal to or greater than 2 and n pixel values are averaged and used to analyze the read data, the minimum pixel value in the read data in a case where the illumination device is turned on is larger than a value obtained by adding a value obtained by dividing the standard deviation by n^{1/2} to the average value of the pixel values of the respective pixels of the read data in the dark state.

### Operation and Effect of Embodiment

The printing system 10 according to the embodiment can obtain the following operation and effect.

### 1

In a case where only the reflected illumination device 38 or only the transmitted bright-field illumination device 40 is used in the reading of the printed image IMG, it is difficult to perform the reading of the printed image IMG, to which appropriate brightness is applied, in each of the measurement of jetting accuracy, the measurement of density unevenness, and the inspection of image defects, due to the influence of the light diffusivity of ink. In the printing system described in the present embodiment, the addition of the transmitted dark-field illumination device 42 makes it possible to perform the reading of the printed image IMG, to which appropriate brightness is applied, in each of the measurement of jetting accuracy, the measurement of density unevenness, and the inspection of image defects.

### 2

The illumination conditions are defined according to the process performed on the read data. Therefore, the illumination conditions in the reading of the printed image suitable for the process performed on the read data are set.

### 3

In a case where the read data is represented by an integer from 0 to 255, the illumination conditions are set such that the pixel value of the non-ink-applied region, in which no ink is applied, in the substrate SU is set to around 230. Therefore, it is avoided that the brightest region in the read data is excessively bright, which makes it impossible to properly read the printed image IMG.

### 4

Only one of the first transmitted dark-field illumination device 42A and the second transmitted dark-field illumination device 42B is turned on. Therefore, the visibility of streaks in the printed image can be improved by using the shadow of the printed image IMG.

### 5

Only one of the first reflected illumination device 38A and the second reflected illumination device 38B is turned on. Therefore, the visibility of streaks in the printed image can be improved by using the shadow of the printed image IMG.

### 6

In a case where the pixel value in the read data is represented by an integer from 0 to 255, the pixel value in the read data of the non-ink-applied region of the substrate SU is adjusted to around 230. In the reading of the printed image in a case of density unevenness correction, the pixel value in the read data of the solid image having a density equal to the density of the region with the minimum amount of ink is compared for each ink color. The illumination conditions are set based on the pixel value in the read data of the ink color with the minimum pixel value. Therefore, the minimum density value of the lightest ink color is not less than the minimum density value in the non-ink-applied region, and the illumination conditions can be set based on the lightest ink color.

That is, the amount of emitted illumination light is adjusted such that, for each ink color, the solid image with the smallest amount of ink and the read data of the non-ink-applied region of the substrate SU can be distinguished from each other for the pixel value of the preferred read data or the average value of a plurality of pixel values.

### 7

In a case where the pixel value in the read data is represented by an integer from 0 to 255, the pixel value in the read data of the non-ink-applied region of the substrate SU is adjusted to around 230. The amount of emitted illumination light is adjusted such that the maximum pixel value of the pixel values in the read data of the ink-applied region is equal to the pixel value in the read data of the non-ink-applied region of the substrate SU. Therefore, the amount of emitted illumination light is adjusted such that the brightness of the region with the lowest ink density is equal to the brightness of the non-ink-applied region of the substrate SU.

### 8

In a case where the pixel value in the read data is represented by an integer from 0 to 255, the pixel value in the read data of the non-ink-applied region of the substrate SU is adjusted to around 230. The amount of emitted illumination light is adjusted such that a region, in which the amount of ink is equal to or less than a prescribed amount, in the ink-applied region is brighter than the non-ink-applied region of the substrate SU. As a result, in a case where only the ink-applied region is subject to inspection and the non-ink-applied region is not subject to inspection, it is possible to improve the SN ratio in the read data. In addition, it is possible to improve the resolution of the pixel value in the read data.

### 9

The amount of emitted illumination light is adjusted such that the maximum pixel value in the read data of the ink-applied region in a state in which the illumination light is emitted is larger than the pixel value in the read data caused by the dark current of the image sensor 32. Therefore, it is possible to reduce the influence of noise in the read data caused by the image sensor 32.

### 10

In one reading operation for one printed image, a plurality of illumination conditions are applied, and the illumination conditions are switched in units of reading lines. Therefore, the read data is generated for each illumination condition.

### Application Example to Reading Device

The reading device 30 provided in the printing system 10 shown in FIG. 1 and the like can be configured as an external device of the printing system 10. That is, a reading device that comprises the image sensor 32, the imaging lens 34, the reflected illumination device 38, the transmitted bright-field illumination device 40, and the transmitted dark-field illumination device 42 shown in FIGS. 1 and 2 and comprises the reading control unit 112 and the reading condition setting unit 124 shown in FIG. 11 can function as the external device of the printing system 10.

The reading device capable of functioning as the external device of the printing system 10 comprises a component having a function related to the control of the reading device 30 of the system control unit 100. The reading device may comprise the reading condition storage unit 126.

### Application Example to Inspection Device

A configuration comprising the reading device 30 provided in the printing system 10 shown in FIG. 1 and the like, and the system control unit 100, the reading control unit 112, and the read data analysis unit 114 shown in FIG. 11 can function as an inspection device for the printed matter output from the printing system. The inspection device may comprise the substrate information acquisition unit 120, the reading condition setting unit 124, and the reading condition storage unit 126.

In the above-described embodiment of the present invention, components can be appropriately changed, added, and removed without departing from the gist of the present invention. The present invention is not limited to the above-described embodiment, and various modifications can be made by those skilled in the art without departing from the technical idea of the present invention. In addition, the embodiment, the modification example, and the application example may be appropriately combined and carried out.

### EXPLANATION OF REFERENCES

10: printing system
12: transport device
14: supply roll
16: support roller
18: collection roll
20: printing device
30: reading device
32: image sensor
34: imaging lens
36: reference plate
38: reflected illumination device
38A: first reflected illumination device
38B: second reflected illumination device
40: transmitted bright-field illumination device
42: transmitted dark-field illumination device
42A: first transmitted dark-field illumination device
42B: second transmitted dark-field illumination device
44: transmitted illumination device
46: light diffusion member
60: fixing device
70: ink supply device
72: maintenance device
100: system control unit
102: transport control unit
104: print control unit
106: fixing control unit
108: ink supply control unit
110: maintenance control unit
112: reading control unit
114: read data analysis unit
120: substrate information acquisition unit
122: print data acquisition unit
124: reading condition setting unit
126: reading condition storage unit
130: storage device
132: sensor
140: reading condition acquisition unit
142: image sensor control unit
144: first reflected illumination control unit
146: second reflected illumination control unit
148: transmitted bright-field illumination control unit
150: first transmitted dark-field illumination control unit
152: second transmitted dark-field illumination control unit
154: read data acquisition unit
200: control device
202: processor
204: computer-readable medium
206: communication interface
208: input/output interface
210: bus
212: memory
214: storage
216: input device
218: display
220: transport control program
222: print control program
224: reading control program
226: read data analysis program
228: fixing control program
230: maintenance control program
232: substrate information
234: reading condition
300: entire read data
302: first partial read data
304: second partial read data
400: illumination device
402: LED light source
404: diffusion plate
406: mirror box
408: movable reflective plate
S10 to S18: each step of reading method
CI: color ink
IMG: printed image
LS: light source
LDP: light diffusion member
M1: motor
M2: motor
M3: motor
NPP: non-ink-applied region
NPF: non-printing surface
OA: optical axis
PF: printing surface
PP: ink-applied region
RL: reflected illumination light
SH: shadow
SU: substrate
TL: transmitted illumination device
TLL: transmitted illumination light
WI: white ink

What is claimed is:

1. A reading device comprising:
an image sensor that reads a printed image printed on a substrate and generates read data of the printed image;
an imaging lens that forms an optical image of the printed image on the image sensor and has a defined visual field representing a range in which an illumination device is disposed such that illumination light is directly incident on the imaging lens;
a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens;
a transmitted illumination condition setting unit that sets transmitted illumination conditions to be applied to the transmitted illumination device; and
one or more first processors,
wherein the transmitted illumination condition setting unit sets illumination conditions to be applied to the transmitted bright-field illumination device and sets illumination conditions to be applied to the transmitted dark-field illumination device, according to a process performed on the read data,
the transmitted illumination condition setting unit defines two or more combinations of the illumination conditions of the transmitted bright-field illumination device and the illumination conditions of the transmitted dark-field illumination device, and sets the combinations of the illumination conditions of the transmitted bright-field illumination device and the illumination conditions of the transmitted dark-field illumination device according to reading conditions of the image sensor, and
the one or more first processors control each of the transmitted bright-field illumination device and the transmitted dark-field illumination device according to the transmitted illumination conditions set by the transmitted illumination condition setting unit.

2. The reading device according to claim 1,
wherein the transmitted illumination condition setting unit sets an amount of light emitted from the transmitted illumination device, based on a first amount of transmitted light obtained from read data acquired by turning on the transmitted bright-field illumination device to read a non-ink-applied region, which is a region in which no ink is applied, of the substrate or a state in which the substrate is absent or a second amount of transmitted light obtained from read data acquired by turning on the transmitted dark-field illumination device to read the non-ink-applied region of the substrate or the state in which the substrate is absent.

3. The reading device according to claim 1, wherein a color sensor or a line sensor is applied as the image sensor.

4. The reading device according to claim 1,
wherein the transmitted dark-field illumination device includes
a first transmitted dark-field illumination device that emits illumination light in a first direction, and
a second transmitted dark-field illumination device that emits illumination light in a second direction different from the first direction.

5. The reading device according to claim 4,
wherein the transmitted illumination condition setting unit sets a first transmitted dark-field illumination condition in which either the first transmitted dark-field illumination device or the second transmitted dark-field illumination device is turned on or a second transmitted dark-field illumination condition in which the first transmitted dark-field illumination device and the second transmitted dark-field illumination device are turned on, according to the process performed on the read data.

6. The reading device according to claim 1,
wherein the transmitted illumination device includes a light diffusion member that diffuses emitted light to at least the transmitted dark-field illumination device.

7. The reading device according to claim 1, further comprising:
a reflected illumination device that is disposed on the same side as the image sensor with respect to a space which is divided into two parts by a plane perpendicular to an optical axis of the imaging lens at a reading position of the image sensor and that irradiates the substrate supported at the reading position with illumination light;
a reflected illumination condition setting unit that sets reflected illumination conditions to be applied to the reflected illumination device; and
one or more second processors,
wherein the one or more second processors control the reflected illumination device according to the reflected illumination conditions.

8. The reading device according to claim 7,
wherein the reflected illumination device includes a first reflected illumination device that emits illumination light in a third direction, and
a second reflected illumination device that emits illumination light in a fourth direction different from the third direction, and
the reflected illumination condition setting unit sets a first reflected illumination condition in which either the first reflected illumination device or the second reflected illumination device is turned on or a second reflected illumination condition in which the first reflected illumination device and the second reflected illumination device are turned on, according to the process performed on the read data.

9. The reading device according to claim 1,
wherein, in a case where a pixel value of read data is larger in a relatively bright portion than in a relatively dark portion in the printed image, the one or more first processors set an amount of light emitted from the transmitted dark-field illumination device such that a maximum value of an average value of pixel values of read data of solid images included in a first test image, which is printed on a transparent substrate and includes a plurality of the solid images having different density values for each of one or more ink colors, exceeds an average value of pixel values of read data in a non-ink-applied region of the substrate.

10. The reading device according to claim 1,
wherein the one or more first processors adjust an amount of light emitted from the transmitted dark-field illumination device such that a maximum pixel value in read data of a printed image printed on a transparent substrate is equal to a pixel value of a non-ink-applied region in the substrate.

11. The reading device according to claim 1,
wherein the one or more first processors adjust an amount of light emitted from the transmitted dark-field illumination device such that a maximum pixel value in read data of a region, in which an amount of ink per unit area is equal to or less than a prescribed amount, among ink-applied regions in a transparent substrate exceeds a pixel value of a non-ink-applied region in the substrate.

12. The reading device according to claim 1,
wherein the one or more first processors adjust an amount of light emitted from the transmitted illumination device such that a minimum pixel value in read data generated by reading the printed image using the image sensor in a state in which the transmitted illumination device is turned on is larger than a pixel value of the read data corresponding to a dark current of the image sensor.

13. The reading device according to claim 1,
wherein the transmitted illumination condition setting unit sets a first transmitted illumination condition and a second transmitted illumination condition different from the first transmitted illumination condition for reading of one printed image,
the one or more processors switch between the first transmitted illumination condition and the second transmitted illumination condition in the reading of the one printed image, and
the image sensor generates first read data to which the first transmitted illumination condition is applied and generates second read data to which the second transmitted illumination condition is applied.

14. A reading method applied to a reading device including an image sensor that reads a printed image printed on a substrate and generates read data of the printed image, an imaging lens that forms an optical image of the printed image on the image sensor and has a defined visual field representing a range in which an illumination device is disposed such that illumination light is directly incident on the imaging lens, and a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens, the reading method comprising:
setting illumination conditions to be applied to the transmitted bright-field illumination device and setting illumination conditions to be applied to the transmitted dark-field illumination device, according to a process performed on the read data;
defining two or more combinations of the illumination conditions of the transmitted bright-field illumination device and the illumination conditions of the transmitted dark-field illumination device, and setting the combinations of the illumination conditions of the transmitted bright-field illumination device and the illumination conditions of the transmitted dark-field illumination device according to reading conditions of the image sensor;
emitting transmitted bright-field illumination light from the transmitted bright-field illumination device according to the illumination conditions of the transmitted bright-field illumination device;
emitting transmitted dark-field illumination light from the transmitted dark-field illumination device according to the illumination conditions of the transmitted dark-field illumination device; and
reading the printed image using the image sensor.

15. A non-transitory, computer-readable tangible recording medium on which a program is recorded, the program being applied to a reading device including an image sensor that reads a printed image printed on a substrate and generates read data of the printed image, an imaging lens that forms an optical image of the printed image on the image sensor and has a defined visual field representing a range in which an illumination device is disposed such that illumination light is directly incident on the imaging lens, and a transmitted illumination device that is disposed at a position facing a light-receiving surface of the image sensor and includes a transmitted bright-field illumination device which is disposed within a range of the visual field of the imaging lens and a transmitted dark-field illumination device which is disposed outside the range of the visual field of the imaging lens, the program causing a computer to implement:
a function of setting illumination conditions to be applied to the transmitted bright-field illumination device and setting illumination conditions to be applied to the transmitted dark-field illumination device, according to a process performed on the read data;
a function of defining two or more combinations of the illumination conditions of the transmitted bright-field illumination device and the illumination conditions of the transmitted dark-field illumination device and setting the combinations of the illumination conditions of the transmitted bright-field illumination device and the illumination conditions of the transmitted dark-field illumination device according to reading conditions of the image sensor;
a function of emitting transmitted bright-field illumination light from the transmitted bright-field illumination device according to the illumination conditions of the transmitted bright-field illumination device;
a function of emitting transmitted dark-field illumination light from the transmitted dark-field illumination device according to the illumination conditions of the transmitted dark-field illumination device; and
a function of reading the printed image using the image sensor.

16. An inspection device comprising:
the reading device according to claim 1; and
an analysis device that analyzes the read data,
wherein the analysis device analyzes a plurality of read data items generated by applying a plurality of different illumination conditions in a case where one type of analysis process is performed.

17. The inspection device according to claim 16,
wherein the transmitted illumination condition setting unit sets a first transmitted illumination condition and a second transmitted illumination condition different from the first transmitted illumination condition for reading of one printed image,
the one or more processors switch between the first transmitted illumination condition and the second transmitted illumination condition in the reading of the one printed image,
the image sensor generates first read data to which the first transmitted illumination condition is applied and generates second read data to which the second transmitted illumination condition is applied, and
the analysis device analyzes the read data items equal in number to a plurality of illumination conditions in a case where one type of analysis process is performed.

18. The inspection device according to claim 16,
wherein the transmitted dark-field illumination device includes a first transmitted dark-field illumination device that emits illumination light in a first direction, and
a second transmitted dark-field illumination device that emits illumination light in a second direction different from the first direction,
the transmitted illumination condition setting unit sets a first transmitted dark-field illumination condition in which either the first transmitted dark-field illumination device or the second transmitted dark-field illumination device is turned on or a second transmitted dark-field illumination condition in which the first transmitted dark-field illumination device and the second transmitted dark-field illumination device are turned on, according to the process performed on the read data, and
the analysis device analyzes the read data to detect a defect in the printed image.

19. The inspection device according to claim 16, further comprising:
a reflected illumination device that is disposed on the same side as the image sensor with respect to a space which is divided into two parts by a plane perpendicular to an optical axis of the imaging lens at a reading position of the image sensor and that irradiates the substrate supported at the reading position with illumination light; and
a reflected illumination condition setting unit that sets reflected illumination conditions to be applied to the reflected illumination device,
wherein the reflected illumination device includes a first reflected illumination device that emits illumination light in a third direction, and
a second reflected illumination device that emits illumination light in a fourth direction different from the third direction,
the reflected illumination condition setting unit sets a first reflected illumination condition in which either the first reflected illumination device or the second reflected illumination device is turned on or a second reflected illumination condition in which the first reflected illumination device and the second reflected illumination device are turned on, and
the analysis device analyzes the read data to detect a defect in the printed image.

20. A reading device comprising:
an image sensor that reads a printed image printed on a substrate and generates read data of the printed image;
an imaging lens that forms an optical image of the printed image on the image sensor and has a defined visual field representing a range in which an illumination device is disposed such that illumination light is directly incident on the imaging lens;
a transmitted illumination device that is disposed at a position facing a light-receiving surface of the image sensor and includes a light diffusion member and a switching member which switches between a proportion of light, which is incident on the light diffusion member and is emitted from within a range of the visual field of the imaging lens, to emitted light and a proportion of light, which is not incident on the light diffusion member and is emitted from outside the range of the visual field of the imaging lens, to the emitted light;
a transmitted illumination condition setting unit that sets transmitted illumination conditions to be applied to the transmitted illumination device; and
one or more first processors,
wherein the transmitted illumination condition setting unit sets transmitted bright-field illumination conditions to be applied to transmitted bright-field illumination light which is emitted from within the range of the visual field of the imaging lens and sets transmitted dark-field illumination conditions to be applied to transmitted dark-field illumination light which is emitted from outside the range of the visual field of the imaging lens, according to a process performed on the read data, and
the one or more first processors control each of the transmitted bright-field illumination light and the transmitted dark-field illumination light according to the transmitted illumination conditions set by the transmitted illumination condition setting unit.
